(19) United States
(12) Patent Application Publication
(10) Pub. No.: US 2025/0371854 A1
(43) Pub. Date: Dec. 4, 2025

(54) NETWORK-TRAINED NEURAL NETWORKS AND ADVERSARIAL-TRAINED NEURAL NETWORKS

(71) Applicant: Mobileye Vision Technologies Ltd., Jerusalem (IL)

(72) Inventors: Eran MALACH, Tel Aviv (IL); Gal KAPLUN, Tel Aviv (IL); Shai SHALEV-SHWARTZ, Jerusalem (IL); Ohad SHITRIT, Ramat-Gan (IL); Abraham HENDLER, Tel Aviv (IL); Tal SWISA, Tel Aviv (IL)

(21) Appl. No.: 19/222,218

(22) Filed: May 29, 2025

Related U.S. Application Data
(60) Provisional application No. 63/654,481, filed on May 31, 2024.
(60) Provisional application No. 63/654,499, filed on May 31, 2024.
(60) Provisional application No. 63/736,063, filed on Dec. 19, 2024.

(51) Int. Cl. G06V 10/778; G06V 10/74; G06V 10/774; G06V 10/776; G06V 10/82

(52) U.S. Cl. CPC G06V 10/7792; G06V 10/761; G06V 10/7747; G06V 10/7753; G06V 10/776; G06V 10/82

(57) ABSTRACT

A system for training a student neural network using a trained supervisory neural network. The system includes at least one processor comprising circuitry and a memory. The memory includes instructions that when executed by the circuitry cause the at least one processor to: receive an image including a representation of a feature of interest, provide the image as input to the trained supervisory neural network, provide the image as input to the student neural network, receive a first output from the trained supervisory neural network indicative of at least one characteristic of the feature of interest, receive a second output from the student neural network indicative of the at least one characteristic of the feature of interest, compare the first output to the second output, and based on a detected difference between the first output and the second output, automatically update at least one aspect of the student neural network.

### CROSS-REFERENCE TO RELATED APPLICATIONS

This application is based upon and claims the benefit of priority from Provisional Application No. 63/654,481, filed on May 31, 2024, Provisional Application No. 63/654,499, filed on May 31, 2024, and Provisional Application No. 63/736,063, filed on Dec. 19, 2024. The entire contents of the above-referenced applications are incorporated herein by reference.

### BACKGROUND

### Technical Field

The present disclosure relates generally to neural networks and, more specifically, to systems and methods for training student neural networks.

### Background Information

The field of supervised learning has witnessed the success of overparameterized methods: models, like deep neural networks, which are large enough to fit their training set but that may still achieve good test performance. One consideration is to understand why such models are able to fit even noisy training data without catastrophically overfitting despite no explicit regularization. It has been proposed that the theoretical framework of benign overfitting may capture this empirical behavior. Briefly, benign overfitting studies statistically consistent methods—where models approach the Bayes optimal function, even in the presence of noise.

However, recent empirical work shows that when training deep neural networks on noisy data, overfitting may not be either catastrophic or benign. Specifically, conventionally it has been proposed that overfitting may not lead to a good classifier, but can lead to a good conditional sampler. For example, a model may be trained on a set of images sampled from some distribution [symbol] , where 20% of the images of cats are wrongly labeled as dogs. An overparameterized network may then be trained to fit samples from [symbol] . Note that for the distribution [symbol] , the Bayes-optimal classifier, namely

$${f}_{𝒟}^{*} ( x ) := arg {max}_{y} {ℙ}_{𝒟} ( y \vert x )$$

should return the “correct” class of every image. Thus, if overfitting were truly “benign”, the overparameterized model would be

$${f}_{𝒟}^{*} .$$

However, this is not what occurs in practice, and instead the trained model ƒ reproduces noise in the training set at test time, labeling up to 20% of the cats in the test data as dogs. In a sense, the trained model ƒ behaves as a conditional sampler: ƒ(x)˜ [symbol] (y|x) (e.g., see the confusion matrix shown at FIG. 4A).

The above example indicates that thinking about classifiers in the overparameterized regime as approximating the Bayes optimal predictor can be misleading. Therefore, it is desirable to develop an appropriate theoretical framework for describing the behavior of samplers from the conditional distribution. While the learning-theoretical aspects of supervised classification are have been considered, the theory of supervised conditional sampling has not been. The embodiments described herein aim to address this gap.

### SUMMARY

According to embodiments of the present disclosure, a system for training a student neural network using a trained supervisory neural network is provided. The system includes at least one processor comprising circuitry and a memory, wherein the memory includes instructions that when executed by the circuitry cause the at least one processor to: receive an image including a representation of a feature of interest, provide the image as input to the trained supervisory neural network, provide the image as input to the student neural network, receive a first output from the trained supervisory neural network indicative of at least one characteristic of the feature of interest, receive a second output from the student neural network indicative of the at least one characteristic of the feature of interest, compare the first output to the second output, and based on a detected difference between the first output and the second output, automatically update at least one aspect of the student neural network.

According to further embodiments of the present disclosure, a method for training a student neural network using a trained supervisory neural network is provided. The method includes receiving an image including a representation of a feature of interest, providing the image as input to the trained supervisory neural network, providing the image as input to the student neural network, receiving a first output from the trained supervisory neural network indicative of at least one characteristic of the feature of interest, receiving a second output from the student neural network indicative of the at least one characteristic of the feature of interest, comparing the first output to the second output, and based on a detected difference between the first output and the second output, automatically updating at least one aspect of the student neural network.

According to further embodiments of the present disclosure, a non-transitory computer-readable medium storing instructions executable by at least one processor to perform a method for training a student neural network using a trained supervisory neural network is provided. The method includes receiving an image including a representation of a feature of interest, providing the image as input to the trained supervisory neural network, providing the image as input to the student neural network, receiving a first output from the trained supervisory neural network indicative of at least one characteristic of the feature of interest, receiving a second output from the student neural network indicative of the at least one characteristic of the feature of interest, comparing the first output to the second output, and based on a detected difference between the first output and the second output, automatically updating at least one aspect of the student neural network.

According to embodiments of the present disclosure, a system for training a student neural network using a trained supervisory neural network, is provided. The system includes at least one processor comprising circuitry and a memory, wherein the memory includes instructions that when executed by the circuitry cause the at least one processor to: receive an image including a representation of a feature of interest, provide the image as input to the trained supervisory neural network, provide the image as input to the student neural network, receive a first output from the trained supervisory neural network indicative of at least one characteristic of the feature of interest, receive a second output from the student neural network indicative of the at least one characteristic of the feature of interest, compare the first output to the second output and based on a detected difference between the first output and the second output: automatically update at least one aspect of the student neural network to provide an updated student neural network, identify at least one refined training image also representative of the feature of interest, provide the refined training image as input to the trained supervisory neural network, provide the refined training image as input to the updated student neural network, receive a third output from the trained supervisory neural network indicative of at least one characteristic of the feature of interest, receive a fourth output from the updated student neural network indicative of the at least one characteristic of the feature of interest, compare the third output to the fourth output, and based on a detected difference between the third output and the fourth output, automatically update at least one aspect of the updated student neural network to provide a further updated student neural network.

According to further embodiments of the present disclosure, a method for training a student neural network using a trained supervisory neural network, is provided. The method includes receiving an image including a representation of a feature of interest, providing the image as input to the trained supervisory neural network, providing the image as input to the student neural network, receiving a first output from the trained supervisory neural network indicative of at least one characteristic of the feature of interest, receiving a second output from the student neural network indicative of the at least one characteristic of the feature of interest, comparing the first output to the second output, and based on a detected difference between the first output and the second output: automatically updating at least one aspect of the student neural network to provide an updated student neural network, identifying at least one refined training image also representative of the feature of interest, providing the refined training image as input to the trained supervisory neural network, providing the refined training image as input to the updated student neural network, receiving a third output from the trained supervisory neural network indicative of at least one characteristic of the feature of interest, receiving a fourth output from the updated student neural network indicative of the at least one characteristic of the feature of interest, comparing the third output to the fourth output, and based on a detected difference between the third output and the fourth output, automatically updating at least one aspect of the updated student neural network to providing a further updated student neural network.

According to still further embodiments of the present disclosure, a non-transitory computer-readable medium storing instructions executable by at least one process to perform a method for training a student neural network using a trained supervisory neural network, is provided. The method includes receiving an image including a representation of a feature of interest, providing the image as input to the trained supervisory neural network, providing the image as input to the student neural network, receiving a first output from the trained supervisory neural network indicative of at least one characteristic of the feature of interest, receiving a second output from the student neural network indicative of the at least one characteristic of the feature of interest, comparing the first output to the second output, and based on a detected difference between the first output and the second output: automatically updating at least one aspect of the student neural network to provide an updated student neural network, identifying at least one refined training image also representative of the feature of interest, providing the refined training image as input to the trained supervisory neural network, providing the refined training image as input to the updated student neural network, receiving a third output from the trained supervisory neural network indicative of at least one characteristic of the feature of interest, receiving a fourth output from the updated student neural network indicative of the at least one characteristic of the feature of interest, comparing the third output to the fourth output, and based on a detected difference between the third output and the fourth output, automatically updating at least one aspect of the updated student neural network to providing a further updated student neural network.

According to still further embodiments, a system for training a student neural network using a trained supervisory neural network, is provided. The system includes at least one processor comprising circuitry and a memory, wherein the memory includes instructions that when executed by the circuitry cause the at least one processor to: receive an image including a representation of a feature of interest, provide the image as input to the trained supervisory neural network, provide the image as input to the student neural network, receive a first output from the trained supervisory neural network indicative of at least one characteristic of the feature of interest, receive a second output from the student neural network indicative of the at least one characteristic of the feature of interest, compare the first output to the second output; and based on a detected difference between the first output and the second output: identify a plurality of refined training images also representative of the feature of interest, provide the plurality of refined training images as input to the trained supervisory neural network, provide the plurality of refined training images as input to the student neural network, receive a first plurality of outputs from the trained supervisory neural network each indicative of at least one characteristic of the feature of interest, receive a second plurality of outputs from the student neural network each indicative of the at least one characteristic of the feature of interest, compare the first plurality of outputs to the second plurality of outputs, and based on one or more detected differences between first plurality of outputs to the second plurality of outputs, automatically update at least one aspect of the student neural network.

According to still further embodiments, a method for training a student neural network using a trained supervisory neural network, is provided. The method includes receiving an image including a representation of a feature of interest, providing the image as input to the trained supervisory neural network, providing the image as input to the student neural network, receiving a first output from the trained supervisory neural network indicative of at least one characteristic of the feature of interest, receiving a second output from the student neural network indicative of the at least one characteristic of the feature of interest, comparing the first output to the second output, and based on a detected difference between the first output and the second output: identifying a plurality of refined training images also representative of the feature of interest, providing the plurality of refined training images as input to the trained supervisory neural network, providing the plurality of refined training images as input to the student neural network, receiving a first plurality of outputs from the trained supervisory neural network each indicative of at least one characteristic of the feature of interest, receiving a second plurality of outputs from the student neural network each indicative of the at least one characteristic of the feature of interest, comparing the first plurality of outputs to the second plurality of outputs, and based on one or more detected differences between first plurality of outputs to the second plurality of outputs, automatically updating at least one aspect of the student neural network.

According to still further embodiments, a non-transitory computer-readable medium storing instructions executable by at least one process to perform a method for training a student neural network using a trained supervisory neural network, is provided. The method comprising receiving an image including a representation of a feature of interest, providing the image as input to the trained supervisory neural network, providing the image as input to the student neural network, receiving a first output from the trained supervisory neural network indicative of at least one characteristic of the feature of interest, receiving a second output from the student neural network indicative of the at least one characteristic of the feature of interest, comparing the first output to the second output, and based on a detected difference between the first output and the second output: identifying a plurality of refined training images also representative of the feature of interest, providing the plurality of refined training images as input to the trained supervisory neural network, providing the plurality of refined training images as input to the student neural network, receiving a first plurality of outputs from the trained supervisory neural network each indicative of at least one characteristic of the feature of interest, receiving a second plurality of outputs from the student neural network each indicative of the at least one characteristic of the feature of interest, comparing the first plurality of outputs to the second plurality of outputs, and based on one or more detected differences between first plurality of outputs to the second plurality of outputs, automatically updating at least one aspect of the student neural network.

### BRIEF DESCRIPTION OF THE DRAWINGS

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIG. 1 illustrates an exemplary vehicle in accordance with one or more aspects of the present disclosure.

FIG. 2 illustrates various exemplary electronic components of a safety system of a vehicle in accordance with one or more aspects of the present disclosure.

FIG. 3A illustrates an example model training architecture, in accordance with one or more aspects of the present disclosure.

FIG. 3B illustrates an example process flow, in accordance with one or more aspects of the present disclosure.

FIG. 3C illustrates another example process flow, in accordance with one or more aspects of the present disclosure.

FIG. 4A illustrates an example confusion matrix showing how a trained model ƒ behaves as a conditional sampler, in accordance with one or more aspects of the present disclosure.

FIG. 4B illustrates an example confusion matrix corresponding to the execution of an ensemble of samplers at inference time, in accordance with one or more aspects of the present disclosure.

FIG. 4C illustrates an example confusion matrix corresponding to the implementation of a distillation algorithm in which each sample is labeled by a random teacher from a fixed set of teachers, in accordance with one or more aspects of the present disclosure.

FIG. 5 illustrates a chart indicating test accuracy versus the number of teachers used, in accordance with one or more aspects of the present disclosure.

FIG. 6 illustrates a representation of an occluded stop sign along a road segment.

FIGS. 7A-H illustrate non-conventional stop sign views that may be selected as training images for input to a student network for further training based on identification when training for edge cases related to failed stop sign identification.

FIGS. 8A-8H illustrate non-conventional open car door views that may may be selected as training images for input to a student network for further training based on identification when training for edge cases related to failed open door identification.

FIG. 9 is a flowchart illustrating a method for adversarial training according to embodiments of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

Many functions today associated with AV systems are performed at least partially by trained models. For example, determination of a minimum safe following distance based on characteristics of a leading vehicle can be determined by suitably trained models, and such determinations may depend on both the trained model and hardware of the vehicle providing input to the model. As another example, predictions regarding the current and future states of parked or seemingly parked vehicles may also be determined by suitably trained models and such predictions used to improve navigation of a host vehicle from which the prediction is made. Again, such predictions may be dependent not only on the trained model but also on the hardware providing inputs to the model.

However, hardware changes (e.g., processing devices, etc., used by vehicle navigation systems) may be desirable from time to time. Similarly, software updates are regularly made to vehicle navigation systems, which may include small feature updates to complete software system architecture overhauls. With hardware and/or software architecture changes, there may be a need for new trained models (e.g., to operate relative to hardware requirements, accept new types of input, comply with required output type, etc.). Developing new trained models from scratch, however, can be costly and time consuming. And in some cases, training data sets used to train earlier legacy models may no longer be available, such that completely new data sets would need to be generated to train a new model to the perform the functionality associated with a legacy system model. Thus, there is a need for techniques to preserve the functionality trained models provide to legacy systems when implementing hardware changes and/or software/software architecture changes. In other words, there is a need for efficiently producing a new set of trained models that provide the functionality of legacy trained models without the need for gathering original training data sets or reliance on training data sets to provide the desired functionality of the legacy systems.

Updating trained models to account for new hardware and new control systems can be repetitive and costly, for at least the reason that the updating involves generation of new trained models. By implementing embodiments of the present disclosure, it may be possible to train new models using an existing model as a supervisor for the training. In other words, the existing model may be used as a training tool to ensure that the new model behaves in the same or similar manner as the supervisory trained model (e.g., the legacy trained model).

New models may be designed and implemented for specific hardware or system software architecture. By implementing embodiments of the present disclosure, operational functionality of existing models can be transferred to new models without having to train the new models using specifically designed training data (e.g., annotated data suggesting a desired outcome). The training according to the described embodiments enables a new model to mimic the performance of supervisor, and results in a more efficient process by way of using unannotated data (e.g., newly available data) and/or only a small set of edge cases, etc., rather than having to train on an original dataset used to train the existing model.

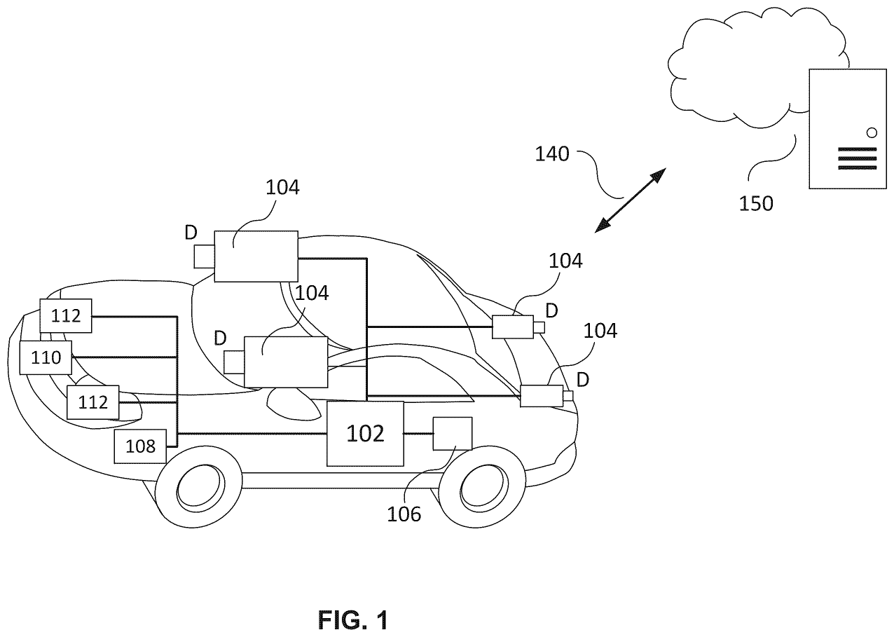

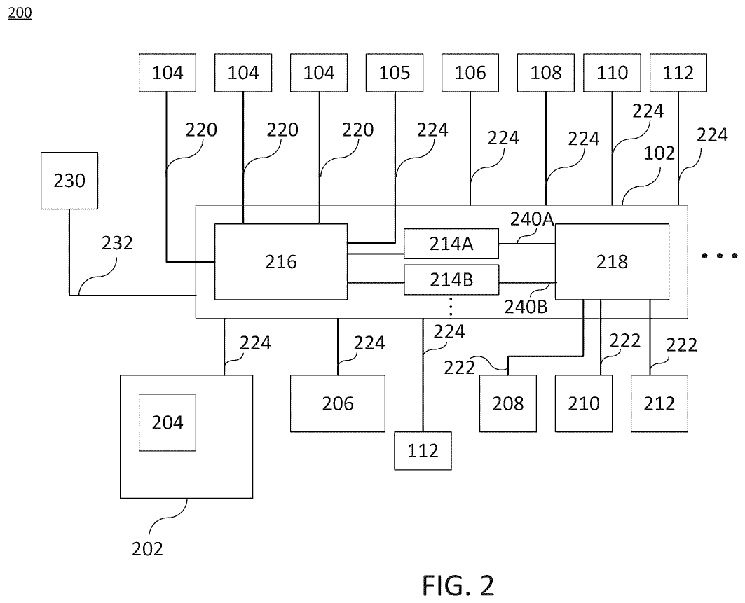

FIG. 1 illustrates a vehicle 100 including a safety system 200 (see also FIG. 2) in accordance with various aspects of the present disclosure. The vehicle 100 and the safety system 200 are exemplary in nature, and may thus be simplified for explanatory purposes. Locations of elements and relational distances (as discussed herein, the Figures are not to scale) are provided by way of example and not limitation.

The safety system 200 may include various components depending on a desired implementation and/or application. For example, components of the safety system 200 may be configured to facilitate navigation and/or control of the vehicle 100.

The vehicle 100 may include any type of vehicle (e.g., a road vehicle) and may be an autonomous vehicle (AV). An autonomous vehicle as used herein may include any level of automation (e.g. levels 0-5), including no automation (level 0) or full automation (level 5). Although embodiments of the present disclosure will be largely discussed in the context of autonomous vehicles, similar approaches may be implemented in other suitable contexts.

The safety system 200 may be implemented with vehicle 100 as part of any suitable type of autonomous or driving assistance control system, including AV and/or an advanced driver-assistance system (ADAS), for instance. The safety system 200 may include one or more components that are integrated as part of the vehicle 100 during manufacture, part of an add-on or aftermarket device, or combinations of these. For example, components of the safety system may include one or more image acquisition devices (e.g., cameras), one or more light distancing and ranging (LiDAR) systems, one or more RADAR systems, and one or more sensors configured to provide data related to characteristics of the vehicle 100 and surroundings of the vehicle 100, among others. Components of the safety system 200 may also include, for example, one or more actuators configured to actuate vehicle systems (e.g., steering, braking, acceleration). Examples of such components are described above in greater detail, and this description being intended to be combined with the presently described embodiments, is not repeated here for sake of brevity.

Thus, the various components of the safety system 200 as shown in FIG. 2 may be integrated as parts of the vehicle systems and/or as parts of an aftermarket system that is installed in the vehicle 100.

The one or more processors 102 may be implemented in any suitable connection configuration with the vehicle 100. For example, the one or more processors 102 may be integrated with or separate from an electronic control unit (ECU) of the vehicle 100 or an engine control unit of the vehicle 100, which may be considered herein as a specialized type of an electronic control unit.

The safety system 200 may generate various data, for example, for controlling or assisting with controlling the ECU and/or other components of the vehicle 100 to directly or indirectly control the driving of the vehicle 100. However, the aspects described herein are not limited to implementations within autonomous or semi-autonomous vehicles, as these are provided by way of example. The aspects described herein may be implemented as part of any suitable type of vehicle that may be capable of travelling with or without any suitable level of human assistance in a particular driving environment. Therefore, one or more of the various vehicle components such as those discussed herein with reference to FIG. 2 for instance, may be implemented as part of a standard vehicle (i.e. a vehicle not using autonomous driving functions), a fully autonomous vehicle, and/or a semi-autonomous vehicle, in various aspects.

In aspects implemented as part of a standard vehicle, it is understood that the safety system 200 may perform alternate functions, for example, blind spot visualization and identification, and thus in accordance with such aspects the safety system 200 may alternatively represent any suitable type of system that may be implemented by a standard vehicle without necessarily utilizing autonomous or semi-autonomous control related functions.

The one or more processors 102 of the safety system 200 may include processors 214A, 214B, 216, and/or 218, one or more image acquisition devices 104 such as, e.g., one or more vehicle cameras or any other suitable sensor configured to perform image acquisition over any suitable range of wavelengths (e.g., RADAR, LiDAR, etc.), one or more position sensors 106, which may be implemented as a position and/or location-identifying system such as a Global Navigation Satellite System (GNSS), e.g., a Global Positioning System (GPS), one or more memories 202, one or more map databases 204, one or more user interfaces 206 (such as, e.g., a display, a touch screen, a microphone, a loudspeaker, one or more buttons and/or switches, and the like), and one or more wireless transceivers 208, 210, 212, among others. Additionally or alternatively, the one or more user interfaces 206 may be identified with other components in communication with the safety system 200, such as one or more components of an ADAS system, an AV system, etc., as further discussed herein.

One or more of the wireless transceivers 208, 210, 212 may additionally or alternatively be configured to enable communications between the vehicle 100 and one or more other remote computing devices 150 via one or more wireless links 140. This may include, for instance, communications with a remote server or other suitable computing system as shown in FIG. 1. The example shown FIG. 1 illustrates such a remote computing system 150 as a cloud computing system, although this is by way of example and not limitation, and the computing system 150 may be implemented in accordance with any suitable architecture and/or network and may constitute one or several physical computers, servers, processors, etc. that comprise such a system. As another example, the remote computing system 150 may be implemented as an edge computing system and/or network.

The one or more processors 102 may implement any suitable type of processing circuitry, other suitable circuitry, memory, etc., and utilize any suitable type of architecture. The one or more processors 102 may be configured as a controller implemented by the vehicle 100 to perform various vehicle control functions, navigational functions, etc. For example, the one or more processors 102 may be configured to function as a controller for the vehicle 100 to analyze sensor data and received communications, to calculate specific actions for the vehicle 100 to execute for navigation and/or control of the vehicle 100, and to cause the corresponding action to be executed, which may be in accordance with an AV or ADAS system, for instance. The one or more processors 102 and/or the safety system 200 may form the entirety of or portion of an advanced driver-assistance system (ADAS) or an autonomous vehicle (AV) system.

Moreover, one or more of the processors 214A, 214B, 216, and/or 218 of the one or more processors 102 may be configured to work in cooperation with one another and/or with other components of the vehicle 100 to collect information about the environment (e.g., sensor data, such as images, depth information (for a LiDAR for example), etc.). In this context, one or more of the processors 214A, 214B, 216, and/or 218 of the one or more processors 102 may be referred to as “processors.”

According to some embodiments, the one or more processors 102 may be configured to implement one or more trained models configured to assist a vehicle in navigating along a road segment. For example, one or more trained models may be configured to provide outputs which a vehicle navigation system may rely upon in developing one or more navigational actions including braking, acceleration, and steering actions. Such actions may be based on one or more detected/inferred features or characteristics of interest represented in a scene captured by an image capture device of an AV or vehicle with ADAS. As another example, one or more trained models may be implemented within an AV or vehicle ADAS to identify features useful for navigation and provide information related to such features to passengers of the vehicle. For example, features such as road signs, traffic signals, etc. may be recognized and conditions associated with the features (e.g., red light, speed limit =50 km/h, etc.) provided via a display device within a vehicle. Trained models may also be implemented in harvesting vehicles to capture information relating to detected objects, scene characteristics, road topography, etc. in the environment of harvesting vehicles that traverse road segments, package the collected information into drive information packets, and transmit the drive information to a mapping server. Additionally, trained models may operate within a mapping server environment or architecture to perform one or more functions associated with map generation (e.g., determining vehicle drivable paths based on road topography features identified in drive information received from harvesting vehicles, among many other functions).

According to some embodiments, the one or more processors may be implemented, independently or together in any desired combination, to perform any desired operations related to vehicle navigation, control, and even information harvesting. According to an example, the one or more processors may be configured to “harvest” data related to the vehicle 100, operation of the vehicle 100, the surroundings of vehicle 100, etc. For example, Road Segment Data (RSD) information that may be used for Road Experience Management (REM) mapping technology, may be harvested (i.e., collected), the details of which are further described below. As another example, the processors can be implemented to process mapping information (e.g. roadbook information used for REM mapping technology) received from remote servers over a wireless communication link (e.g. link 140) to localize the vehicle 100 on an AV map, which can be used by the processors to control the vehicle 100.

The one or more processors 102 may include one or more application processors 214A, 214B, an image processor 216, a communication processor 218, and may additionally or alternatively include any other suitable processing device, circuitry, components, etc. not shown in the Figures for purposes of brevity.

Similarly, image acquisition devices 104 may include any suitable number of image acquisition devices and components depending on the requirements of a particular application. Image acquisition devices 104 may include one or more image capture devices (e.g., cameras, charge coupling devices (CCDs), or any other type of image sensor).

The safety system 200 may also include a data interface communicatively connecting the one or more processors 102 to the one or more image acquisition devices 104. For example, a first data interface may include any wired and/or wireless first link 220, or first links 220 for transmitting image data acquired by the one or more image acquisition devices 104 to the one or more processors 102, e.g., to the image processor 216.

The one or more memories 202, as well as the one or more user interfaces 206, may be coupled to each of the one or more processors 102, e.g., via a third data interface. The third data interface may include any suitable wired and/or wireless third link 224 or third links 224. Furthermore, the position sensors 106 may be coupled to each of the one or more processors 102, e.g., via the third data interface.

Each processor 214A, 214B, 216, 218 of the one or more processors 102 may be implemented as any suitable number and/or type of hardware-based processing devices (e.g. processing circuitry), and may collectively, i.e. with the one or more processors 102 form one or more types of controllers as discussed herein. The architecture shown in FIG. 2 is provided for case of explanation and as an example, and the vehicle 100 may include any suitable number of the one or more processors 102, each of which may be similarly configured to utilize data received via the various interfaces and to perform one or more specific tasks.

A relevant memory accessed by the one or more processors 214A, 214B, 216, 218 (e.g. the one or more memories 202) may also store one or more databases and image processing software, as well as a trained system, such as a neural network, or a deep neural network, for example, that may be utilized to perform the tasks in accordance with any of the aspects as discussed herein. A relevant memory accessed by the one or more processors 214A, 214B, 216, 218 (e.g. the one or more memories 202) may be implemented as any suitable number and/or type of non-transitory computer-readable medium such as random-access memories, read only memories, flash memories, disk drives, optical storage, tape storage, removable storage, or any other suitable types of storage.

The components associated with the safety system 200 as shown in FIG. 2 are illustrated for case of explanation and by way of example and not limitation. The safety system 200 may include additional, fewer, or alternate components as shown and discussed herein with reference to FIG. 2. Moreover, one or more components of the safety system 200 may be integrated or otherwise combined into common processing circuitry components or separated from those shown in FIG. 2 to form distinct and separate components. For instance, one or more of the components of the safety system 200 may be integrated with one another on a common die or chip. As an illustrative example, the one or more processors 102 and the relevant memory accessed by the one or more processors 214A, 214B, 216, 218 (e.g. the one or more memories 202) may be integrated on a common chip, die, package, etc., and together comprise a controller or system configured to perform one or more specific tasks or functions. Again, such a controller or system may be configured to execute the various to perform functions related to issuing warnings and/or controlling various aspects of the vehicle 100, as discussed in further detail herein, to present relevant warnings and/or to control of the state of the vehicle 100 in which the safety system 200 is implemented.

Embodiments of the present disclosure may enable implementation of one or more trained systems, also referred to herein as “supervisors” or “trained supervisory neural networks,” configured to “teach” (i.e., train) one or more student systems, also referred to herein as “learners” or “student neural networks,” based on the output of the teacher to enable the student to mimic the output of the teacher in response to inputs not previously “seen” or “experienced” by the student. In other words, embodiments of the present disclosure can create one or more additional trained models capable of recognizing new inputs based on the teachings of the teacher network and absent any further human intervention. Such systems may be implemented, for example, to enable modifications to systems associated with the illustrative vehicle discussed above, e.g., where hardware and/or software changes are desired without loss of legacy functionality.

### Example Architecture for Model Training

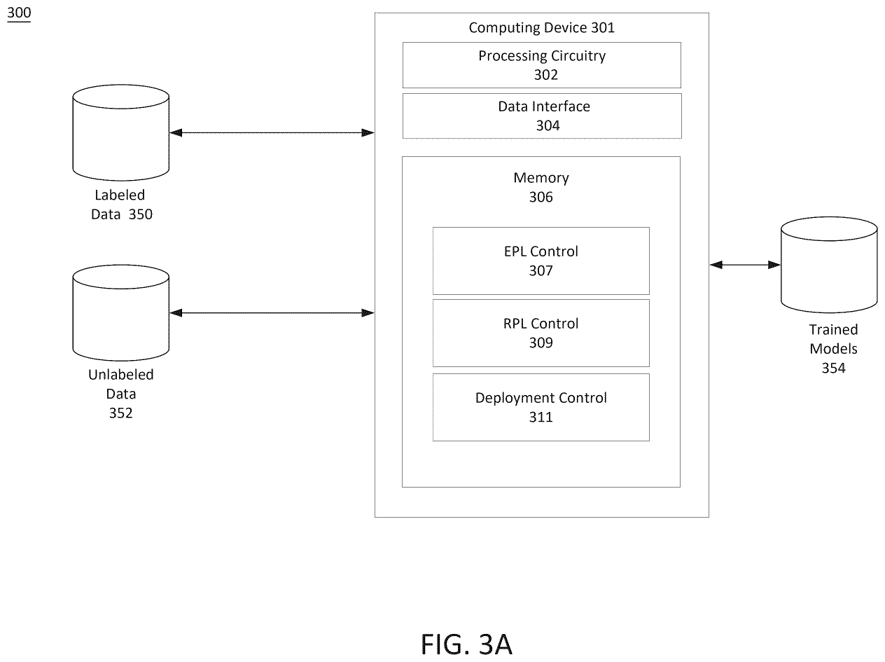

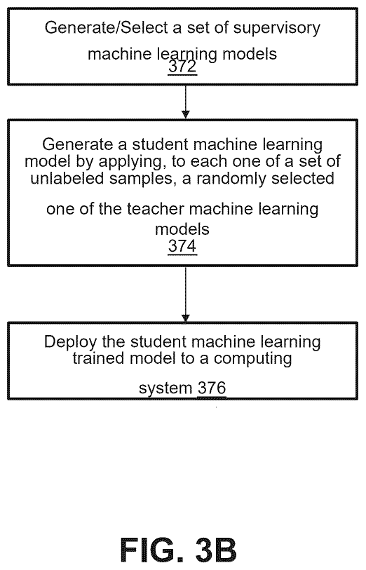

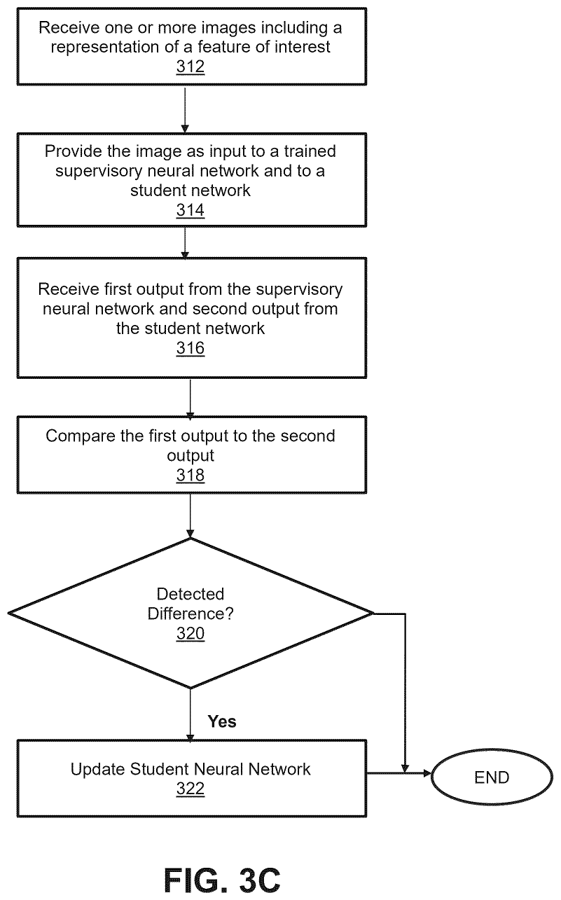

FIG. 3A illustrates a block diagram of an exemplary architecture for model training, in accordance with aspects of the disclosure. In an aspect, the architecture 300 comprises one or more computing devices 301, as well as data storage components 350, 352, 354. The data storage components 350, 352, 354 are shown in FIG. 3A and described herein with respect to the different types of data that are used and/or generated via the architecture 300 for ease of explanation. However, it is understood that in various embodiments any of the data storage components 350, 352, 354 may additionally or alternatively be integrated as part of the computing device 301, such as part of the memory 306 for instance.

The data storage components 350, 352, 354 may be implemented as any suitable number and/or type of storage components, such as non-volatile memory, volatile memory, etc. Moreover, each of the data storage components 350, 352, 354 may be configured to store data in any suitable format, such as e.g. a database architecture, a cloud architecture, a virtual cloud architecture, storage identified with a server or other suitable computing device, etc. When implemented as external and/or separate components, the computing device 301 may be configured to read data from and/or write data to any of the data storage components 350, 352, 354. The computing device 301 and the data storage components 350, 352, 354 may thus be communicatively coupled to one another via any suitable number of communication links for this purpose, which may be any suitable combination of wired and/or wireless links.

The labeled dataset stored in the data storage component 350 may comprise any suitable number of labeled data samples of any suitable type depending upon the particular model that is to be trained. For example, the labeled dataset may comprise a large number (e.g. 100, 10,000, a million or more, for example, 5 million, etc.) of images of objects and their classifications (i.e., labels). If the labeled dataset is used in accordance with a vehicle function as further described herein, the labeled dataset may comprise images and corresponding labels of pedestrians, traffic signs, vehicles, road markings, traffic signals, etc.

Additionally, according to some embodiments, the labeled dataset may include images and corresponding labels associated with characteristics and/or conditions of one or more objects represented in the dataset. For example, a condition associated with at least one object may include at least one of an occlusion, a shadow, an object orientation, a traffic light illumination state, a reflectivity level, a moisture level, or an ambient light level.

The unlabeled dataset stored in the data storage component 352 may likewise comprise any suitable number of unlabeled data samples of any suitable type depending upon the particular model that is to be trained. For example, the unlabeled dataset may also comprise a large number (e.g. 100, 10,000, a million or more, e.g., 5 million, etc.) of images of objects but without their associated classifications (i.e., labels). Using the previous example, if the unlabeled dataset is used in accordance with a vehicle function, the unlabeled dataset may comprise images of various traffic scenes that include pedestrians, traffic signs, vehicles, road markings, traffic signals, etc., but without labels or annotations.

Additionally, according to some embodiments, the unlabeled dataset may include images associated with characteristics and/or conditions of one or more objects represented in the dataset. For example, the condition associated with at least one object may include similar conditions to those noted with regard to a labelled dataset, e.g., at least one of an occlusion, a shadow, an object orientation, a traffic light illumination state, a reflectivity level, a moisture level, or an ambient light level.

The computing device 301 as shown and described with respect to FIG. 3A may be identified as a standalone device that may be utilized to perform the aspects as described herein inside or outside of a vehicular environment. Thus, the computing device 301 may perform the functionality as described herein with respect to the in-vehicle processor(s) 102 as discussed above with respect to FIGS. 1 and 2. When implemented as a standalone device, the computing device 301 may be implemented as any suitable computing device such as a personal computer, a server computer, a cloud-based server computer, a mobile device, etc. For example, the computing device 301 may be identified with the one or more other remote computing devices 150, and which may communicate with the vehicle 100 via one or more wireless links 140 (e.g. for deployment of the trained model(s)). When implemented as part of the vehicle 100, the computing device 301 may represent any suitable portion of the safety system 200 as discussed herein. For example, the computing device 301 may be implemented as an ECU or other suitable in-vehicle component configured to communicate with one or more of the components of the safety system 200 as discussed herein.

In any event, the computing device 301 is configured to perform the various functions as discussed herein to perform model training, deployment, and/or use (e.g. at inference time) of the trained and deployed models in accordance with any suitable application for which the models have been trained. In this context, it is noted that the computing device used to perform the training, deployment, and use of the trained and deployed models may be the same computing device or different computing devices. For instance, the models may be trained by a computing device 301 that is external to the vehicle 100, and then subsequently deployed and used by the vehicle safety system 200.

To provide another example, the computing device 301 may comprise part of the safety system 200, as noted above, and may perform one or more (or all) of the steps for model training, deployment, and use as part of the operation of the vehicle 100. Furthermore, although at times referred to herein in a singular sense, the embodiments include the training, deployment, and/or use of any suitable number of models, which may support any suitable number and/or type of different functions and/or applications.

When implemented as part of a vehicle, the computing device 301 may be configured to receive as inputs, for example, any suitable type of data that may be used in accordance with the deployed trained model(s) to enable a vehicle function. The type of data received in this manner is a function of the type of application for which the model has been trained. For example, the model may be trained to perform, as the vehicle function, any suitable type of classification techniques. This may include object classification for example, which may be particularly useful in the context of autonomous and/or ADAS vehicle systems.

Continuing this example, the computing device 301 may be configured to receive sensor data from any suitable number and/or type of sensor sources implemented via the safety system 200, such as images acquired via the image acquisition devices 104, data acquired via IMU sensors such as compasses, gyroscopes, accelerometers, etc., ultrasonic sensors, infrared sensors, thermal sensors, digital compasses, RADAR, LIDAR, optical sensors, etc.

Although described herein in the context of performing a vehicle function, the embodiments described herein are not limited in this regard, and the training, deployment, and use of the trained models as discussed herein may be performed in accordance with any suitable application for which models are trained. To do so, the computing device 301 may include processing circuitry 302, a data interface 304, and a memory 306. The components shown in FIG. 3A are provided for case of explanation, and aspects include the computing device 301 implementing additional, less, or alternative components to those shown in FIG. 3A.

In various aspects, the processing circuitry 302 may be configured as any suitable number and/or type of computer processors, which may function to control the computing device 301 and/or components of the computing device 301. The processing circuitry 302 may be identified with one or more processors (or suitable portions thereof) implemented by the computing device 301. For example, the processing circuitry 302 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc. In an embodiment, the processing circuitry 302 may be identified with the in-vehicle processor(s) 102 as described herein with respect to the safety system 200, e.g. when the computing device 301 is implemented as part of an in-vehicle component and/or part of the safety system 200.

In any event, aspects include the processing circuitry 302 being configured to carry out instructions to perform arithmetical, logical, and/or input/output (I/O) operations, and/or to control the operation of one or more components of computing device 301 to perform various functions associated with the aspects as described herein. For example, the processing circuitry 302 may include one or more microprocessor cores, memory registers, buffers, clocks, etc., and may generate electronic control signals associated with the components of the computing device 302 to control and/or modify the operation of these components. For example, aspects include the processing circuitry 302 communicating with and/or controlling functions associated with the data interface 304 and/or the memory 306. The processing circuitry 302 may additionally perform various operations as discussed herein with reference to the one or more processors of the safety system 200 identified with the vehicle 100.

According to some embodiments, the data interface 304 may be implemented as any suitable number and/or type of components configured to transmit and/or receive data and/or wireless signals in accordance with any suitable number and/or type of communication protocols. The data interface 304 may include any suitable type of components to facilitate this functionality, including components associated with known transceiver, transmitter, and/or receiver operation, configurations, and implementations. The data interface 304 may include components typically identified with wired and/or wireless data interfaces, such as e.g. an RF front end, antennas, ports, power amplifiers (PAs), RF filters, mixers, local oscillators (LOs), low noise amplifiers (LNAs), upconverters, downconverters, channel tuners, buffers, drivers, etc.

Regardless of the particular implementation, the data interface 304 may include one or more components configured to transmit data that is written to one or more of the storage components 350, 352, 354 and/or to read and receive data from the one or more of the storage components 350, 352, 354 as discussed herein, which may be used to train, deploy, and/or use trained models.

In an aspect, the memory 306 stores data and/or instructions such that, when the instructions are executed by the processing circuitry 302, cause the computing device 301 to perform various functions as described herein, such as those described above, for example. The memory 306 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 306 may be non-removable, removable, or a combination of both. For example, the memory 306 may be implemented as a non-transitory computer readable medium storing one or more executable instructions such as, for example, logic, algorithms, code, etc.

As further discussed below, the instructions, logic, code, etc., stored in the memory 306 are represented by the various modules as shown in FIG. 3A, which may enable the aspects disclosed herein to be functionally realized.

Alternatively, if the aspects described herein are implemented via hardware, the modules shown in FIG. 3A associated with the memory 306 may include instructions and/or code to facilitate control and/or monitor the operation of such hardware components. In other words, the modules shown in FIG. 3A are provided for case of explanation regarding the functional association between hardware and software components. Thus, aspects include the processing circuitry 302 executing the instructions stored in these respective modules in conjunction with one or more hardware components to perform the various functions associated with the aspects as further discussed herein.

According to some embodiments, the executable instructions stored in the Ensemble-Pseudo-Labeling (EPL) control module 307 may facilitate, in conjunction with execution via the processing circuitry 302, the computing device 301 executing an EPL algorithm to generate trained models. To do so, it is noted that the various “samplers,” “learners,” and “teachers” described herein may be implemented as trained models. These models may be trained in accordance with any suitable type of training algorithm, such as a machine learning training algorithm which may include an artificial neural network, a convolutional neural network, etc. For instance, the algorithms used to generate the trained models may comprise, for instance, Nearest Neighbor algorithms, Naive Bayes, Decision Trees, Linear Regression, Support Vector Machines (SVM), Neural Networks, etc.

Thus, as an initial step, which was described above, an ensemble of teachers may be generated via the execution of the EPL algorithm, or may have been previously generated via any suitable algorithm. Thus, an ensemble of teachers may represent a set of machine learning trained models that meet a predetermined set of conditions, such as those described above in Definition 7, for example.

To provide an illustrative example, the predetermined set of machine learning trained models, which constitute the ensemble of teachers as discussed herein, function to output a classifier from unlabeled data that approximates the Bayes optimal predictor. Approximation in this context means that the probabilities of classifications generated by the predetermined set of machine learning trained models are within a threshold probability compared to the output of the Bayes optimal predictor with respect to the same dataset. As noted above, predetermined set of machine learning trained models may produce outputs that replicate a noise distribution of samples in the labeled dataset, which the embodiments address, as noted herein.

Thus, the EPL algorithm functions to generate and/or utilize a set of predetermined machine learning trained models that constitute the “teachers” as discussed herein by identifying machine learning models that meet a set of predefined conditions. These predefined conditions are described above in Section 2.2 by way of example and not limitation. That is, in order to qualify as one of the ensemble members used for the EPL algorithm, each machine learning trained model in the predetermined set of trained models should meet these conditions.

For instance, a first condition may include a Bayes optimal probability distribution associated with the labeled dataset and a probability distribution of output data generated via a machine learning trained model being within a threshold value of one another. An additional or alternative second condition may comprise a probability mass of a subset of margin samples from output data generated via a candidate machine learning trained model being less than a threshold value.

Thus, the ensemble of teachers constitute a set of predetermined machine learning trained models that are generated (via the EPL algorithm or another suitable algorithm, e.g., the RPL algorithm) using the labeled data stored in the data storage component 350. This ensemble of teachers, i.e. the set of predetermined machine learning models, are thus selected based upon each one meeting one or more conditions, e.g. those described above. Once the predetermined set of machine learning trained models are selected and/or generated, the EPL/RPL algorithms function to generate a machine learning trained model using the unlabeled data from the storage component 352.

Again, this results in the training of a new classifier to imitate the ensemble, as discussed above. The EPL algorithm and/or the RPL algorithm may perform this training as part of a knowledge distillation process by applying each one of the predetermined set of machine learning trained models to an unlabeled sample retrieved from the unlabeled dataset, which may constitute one sample from hundreds, thousands, millions, etc. For example, an EPL and/or an RPL algorithm may be configured to compare outputs of a teacher (e.g., an ensemble) to the output of a student based on one or more characteristics of a feature of interest (e.g., a road sign, a road marking, a traffic signal, etc.) Based on any detected differences between the output of the teacher and the output of the student, the chosen algorithm may be configured to automatically update at least one aspect of the student neural network.

According to some embodiments, the output of the teacher may correspond to a first feature vector determined by the teacher as representative of the feature of interest. Similarly, the output of the student may correspond to a second feature vector determined by the student as representative of the same feature of interest. In this way, the EPL and/or the RPL may determine one or more differences between the feature vectors, for example, by calculating a Euclidian distance between the first feature vector and the second feature vector.

Following determination of one or more differences, the algorithm may update at least one aspect of the student neural network. For example, one or more parameters of the student neural network may be adjusted, including, for example, at least one weight of the student neural network may be adjusted based on the calculated Euclidian distance.

Each one of the predetermined set of machine learning trained models may then output a labeled (i.e. classified) sample, which may represent a probability value for instance. The output of each of the predetermined set of machine learning trained models may then be averaged together to provide an output classifier, which represents the output of the trained model, i.e., the “student” as discussed herein.

Once trained in this manner to leverage knowledge distillation, the trained “student” model may be subsequently deployed and used as noted herein. For example, according to some embodiments, the executable instructions stored in the deployment control module 311 may facilitate, in conjunction with execution via the processing circuitry 302, the computing device 301 deploying the trained model to a suitable computing system in accordance with a particular application.

Again, by way of example and not limitation, this may include the trained model being deployed as part of a safety system or other suitable components of a vehicle (e.g. an autonomous or semi-autonomous vehicle), which may utilize received sensor data or other suitable data to enable a vehicle function. The vehicle function may comprise object classification or any other suitable type of function based upon the functionality of the trained model and the expected input and output data.

The deployment control module 311 may thus facilitate the deployment, when necessary, of the trained model from the computing device 301 to another computing system in which the trained model will be implemented. This may be performed, for instance, via the data interface 304 by transmitting and/or transferring the trained model to the appropriate computing system.

As noted above, the use of the EPL algorithm advantageously moves the computational burden from inference time to training time, although the labeling of each sample still remains a computational burden. Thus, in an embodiment, the executable instructions stored in the Random-Pseudo-Labeling (RPL) model 309 may facilitate, in conjunction with execution via the processing circuitry 302, the computing device 301 generating a trained model by leveraging a randomly selected ensemble approach.

It is noted that the trained models generated via the RPL algorithm may be used in accordance with the same applications (e.g. deployment for vehicle functions) as discussed above with respect to the EPL algorithms, and therefore only differences between these two algorithms are further discussed below for purposes of brevity. For example, the EPL and the RPL algorithms both leverage the use of an ensemble, i.e. a predetermined set of trained models that meet one or more predefined conditions, examples of which were described above. Moreover, both the EPL and the RPL algorithms may be implemented to generate a trained model using a knowledge distillation process, which may then be deployed for use in a computing device such as a vehicle to perform vehicle functions, e.g. object classification.

However, in contrast to the EPL algorithm, the RPL algorithm may generate a machine learning trained model by applying, for each sample in the unlabeled dataset, a randomly selected one of the predetermined set of trained models. That is, instead of applying each of the predetermined set of trained models to each unlabeled sample, one of the predetermined set of trained models may be randomly selected and applied to each unlabeled sample to generate labeled data. This may be repeated for any suitable number of unlabeled samples, and may result in a less computationally intensive training process compared to the EPL algorithm.

As discussed in further detail above, the random use of one of the ensemble members may allow for the labeled data generated by the trained (i.e. “student”) model in this way to have a reduced noise distribution. Specifically, the noise distribution of the labeled data output by the trained model may be less than the noise distribution of samples in the labeled dataset, which again may be replicated by the predetermined set of trained models as noted above. In other words, the use of the RPL algorithm in this manner may help to ensure that the noise is not sampled and passed to the output of the trained model, as was the case for the predetermined set of trained models due to their sampling effect.

Furthermore, because the distillation is performed in this manner from a random selection among an ensemble of teachers, the resulting trained model may yield a low error with respect to the Bayes optimal. In other words, the model trained in accordance with the RPL algorithm advantageously provides a trained model that may generate labeled data from unlabeled data within a predetermined threshold of Bayes class-probabilities generated via a Bayes optimal classifier. Embodiments include, for both the EPL and RPL algorithms, defining a predetermined threshold that is met upon generating the trained model, such that accuracy of classifications is ensured.

It should be noted that any number of student models may be trained by any number of supervisor models. For example, in some cases, a single student model is trained to mimic the output of a single supervisor model based on unannotated data provided to both the supervisor and the student. In some cases, as described above, a plurality of supervisor models may be used to train a similar number of student models such that the student models learn to mimic the output of their corresponding supervisor model. And, in some cases, a plurality of supervisor models may be used to train a single student model, such that the student model learns to mimic the outputs of the plurality of supervisor models. In this way, the different functions associated with a plurality of legacy trained models may be imparted to a single student model through the described training techniques.

### Example Process Flows

FIGS. 3B and 3C illustrate example process flows, in accordance with one or more aspects of the present disclosure. The functionality associated with the blocks as discussed herein with reference to FIGS. 3B and 3C may be executed, for instance, via processing circuitry associated with any suitable computing system, e.g., the safety system 200, and/or a computing device, as described in greater detail below. This may include, for example, one or more processors 102 executing instructions stored in a suitable memory, processing circuitry, etc. The processing circuitry may implement the aspects as described herein as part of an ADAS and/or AV system of the vehicle 100, or may be executed independently of such systems to implement the aspects as described herein (e.g., on a user's home or office computing device, a mobile device, etc.)

According to some embodiments of the present disclosure, one or more supervisory machine learning trained models may be generated and/or selected (block 372) using a labeled dataset comprising labeled data (e.g., ground truth data.) The set of first machine learning trained models may, for example, comprise the ensemble of “teachers” as discussed herein, and be generated and/or selected based upon machine learning models that meet predefined conditions (e.g., having output meeting quality metrics and other criteria described below.)

One or more student machine learning trained models may be generated (block 374) by applying, to each one of a set of samples in an unlabeled dataset, a randomly selected one of the set of first machine learning trained models. This may include, for instance, generating a trained “student” model as discussed herein in accordance with, for example, a Random-Pseudo-Labeling (RPL) algorithm.

The one or more student machine learning trained models may be deployed (block 376) to a suitable computing system. For example, deployment may include implementing a student machine learning trained model within a safety system 200 or other suitable computing system, e.g. one identified with a vehicle. The student machine learning trained models, once deployed, may be utilized to perform vehicle functions such as, for example, object classification, navigation action determination, etc.

The disclosed embodiments may use one or more already-trained supervisory neural networks (e.g., a teacher network) to pass along the training and/or capabilities to another neural network (e.g., a student network). One advantage is that the new neural network, while acquiring the capabilities of the teacher neural network, could be developed relative to the constraints of a particular hardware platform for which the teacher neural networks were not developed. As a corollary, teacher neural networks can be developed without constraint by specific hardware limitations.

Alternatively, teacher neural networks designed for use with legacy hardware platforms can still be used for training new student neural networks intended for operation on new hardware platforms. Another advantage is that the student neural network potentially can achieve better performance than the teacher neural networks, for example, where a teacher neural network, trained relative to a finite data set, may have noisy performance and may be wrong in some cases. A student neural network may be trained by matching the output of the teacher relative to an unlimited data set. Statistical errors of the teacher neural network can be smoothed through exposure to very large datasets—thus, potentially resulting in a better performing neural network. Another significant advantage—training of the student neural network (new neural networks may not require labeled datasets.)

Embodiments of the present disclosure may implement one or more trained systems (e.g., neural network) trained using one or more techniques disclosed herein, e.g., trained in an overparameterized regime, to subsequently act as a conditional sampler, corresponding to a “teacher” in the context of the present disclosure. A plurality of conditional samplers (i.e., “teachers”) can be implemented as an “ensemble” in a hardware independent manner, to subsequently train one or more models (e.g., neural networks) corresponding to “students.” For example, a student neural network may be trained by matching an output of the teacher or ensemble of teachers relative to, for example, an unlimited data set.

According to some embodiments, statistical errors of teacher systems may be smoothed through, for example, exposure to large datasets (e.g., datasets having a size of 100,000 samples, 1 million samples, etc.) thus, potentially resulting in improved performance for a resulting trained system (e.g., a trained neural network). One further advantage of the disclosed embodiments is that training of the student systems may not require the use of labeled datasets. In other words, human intervention for labelling datasets, as well as generation of new training datasets (e.g., synthetically generated and/or annotated) may be avoided.

Some trained systems (e.g., large neural networks) configured for image processing (e.g., image segmentation and computer vision) trained in the overparameterized regime may enable fitting of noisy data to zero-train error. In other words, despite the presence of noise in the training data, the resulting error is at or near zero.

It has been observed that such trained systems may behave as “conditional samplers” based on the noisy distribution with which they were trained. Thus, the systems trained in this way may replicate the noise in the training data to unseen examples, i.e., data that was not part of the training data. The following disclosure provides a framework for implementing the resulting conditional sampling behavior to improve machine learning for one or more trained systems (e.g., neural networks).

Conditional samplers as described herein relate to knowledge distillation, where, for example, a “student” network (also referred to herein as a “learner”) may be configured (i.e., trained) to imitate the outputs of a “teacher” network on, for example, unlabeled data. Conditional samplers, while being generally less desirable as image classifiers, may be suitably implemented as a “teacher” network. As will be described below, knowledge distillation from one or more conditional samplers may produce a student network which approximates and/or approaches a Bayes optimal classifier.

Learning algorithms that may be useful for implementation as conditional samplers may include, for example, Nearest-Neighbors and Kernel Machines when applied in an overparameterized regime. In addition, Lipschitz classes such as linear methods, kernels, and neural networks may also behave like conditional samplers when applied in an overparameterized regime. These examples are not intended as limiting, and any suitable learning algorithms may be implemented as conditional samplers in the context of the present disclosure as desired.

Knowledge distillation may be described as a process of training a “teacher” network on a small, labeled dataset and using predictions of the teacher network to label a large unlabeled dataset, on which a student network is subsequently trained to imitate the output of the teacher. As further described herein, by taking an ensemble of conditional samplers (i.e., a collection or plurality of conditional samplers) acting as a teacher network for knowledge distillation may produce one or more student networks with minimal error with respect to the Bayes optimal classifier. The embodiments as discussed herein further lead to a new system for knowledge distillation, where a teacher network may be randomly selected from a fixed pool of the ensemble to label each sample, which may accelerate the training process for the student network. It is further shown that systems and methods implemented according to embodiments of the present disclosure provide a reasonable basis for producing a student network having low error (e.g., less than 1%, less than 0.5%, etc.)

Systems and methods of the present disclosure may be implemented on any suitable hardware for operating a machine learning platform. Such systems may relate to training a student neural network using a trained supervisory neural network, also referred to as a teacher. For example, such systems may include at least one processor comprising circuitry and a memory as described above. The memory may include instructions that when executed by the circuitry cause the at least one processor to perform operations according to embodiments of the present disclosure.

The trained supervisory neural network and the student neural network may be hosted on different hardware platforms or may be hosted on the same hardware platform, as desired. For example, the trained supervisory neural network may be executed on server, while the student neural network may be executed in the context of a vehicle safety system (e.g., using the vehicle electronic control unit (ECU)). In such cases, inputs and outputs of each system may be communicated by any suitable means, e.g., wired connections, wirelessly, etc.

Turning to FIG. 3C, according to some embodiments, the processor may be configured to receive one or more images including a representation of a feature of interest (block 312). The one or more images may be received from, for example, one or more image repositories, e.g., an image database, and may be representative of any scene including representations of features of interest. For example, images including environments surrounding a vehicle navigating a road segment may be used for models associated with safety system 200 in the context of a driver assistance system.

The one or more received images may be void of any annotations. For example, the one or more images may include features of interest related to scenarios in which the student networks may be implemented, and may be void of any labels denoting or otherwise defining the features of interest in the one or more images. Following examples described herein, for an AV or ADAS, the features of interest may include, e.g., traffic signs, pedestrians, vehicles, lane markings, road edges, etc. but the features of interest may not be labeled with any indication of to what the features correspond.

According to another example, the features of interest may include a condition associated with at least one object such as, for example, an occlusion, a shadow, an object orientation, a traffic light illumination state, a reflectivity level, a moisture level, or an ambient light level. The one or more images may not contain any labels indicating to what condition the features of interest correspond.

The one or more images may be provided as input to both a trained supervisory neural network (a teacher network) and one or more student neural networks (block 314). First output from the trained supervisory neural network indicative of at least one characteristic of the feature of interest and second output from the student neural network indicative of the at least one characteristic of the feature of interest may then be received (block 316) and compared (block 318) to determine whether a difference exists between the first output and the second output. For example, the outputs may correspond to feature vectors and the vectors may be compared using a Euclidean distance, a Manhattan distance, etc.

Where the determined distance is greater than a predetermined value (block 320: yes), it may be determined that a difference exists, and that the student neural network should be updated. The student neural network may be updated (block 322), for example, changing one or more parameters of the student neural network to reduce the difference between the first output and the second output. According to some embodiments, the one or more parameters of the student neural network includes weights, biases, and/or any other suitable parameter configured to reduce the distance between the output vectors of the teacher and the student.

Additional technical details are provided below to aid in implementation of embodiments of the present disclosure. The technical details below are not intended as limiting and serve as examples of how the present inventors have chosen to implement the claimed systems and methods.

A basic description of conditional sampling is provided herein in the context of computational learning theory. However, this description is not intended to limit the scope of the present disclosure. For example, distributions may exist where sampling is facilitated over classification, using fewer samples, but by implementing a polynomial blowup in sample-size and runtime, a conditional sampler can be “boosted” to become a suitable classifier. Other implementations outside the basic description provided herein will be readily understood upon review of the present disclosure.

According to some embodiments, a conditional sampler may be converted into a suitable classifier by executing an ensemble (i.e., a plurality) of conditional samplers at inference time, which may be costly from a resource perspective. For example, two, three, four, ten, or even more conditional samplers may be executed at inference time to approximate a Bayes optimal classifier.

According to some embodiments, knowledge distillation may be performed from such an ensemble of teacher networks, which can result in a student network with low error with respect to the Bayes optimal. Therefore, a teacher network in ensemble-distillation may not necessarily be a suitable classifier, but may be configured as a suitable sampler.

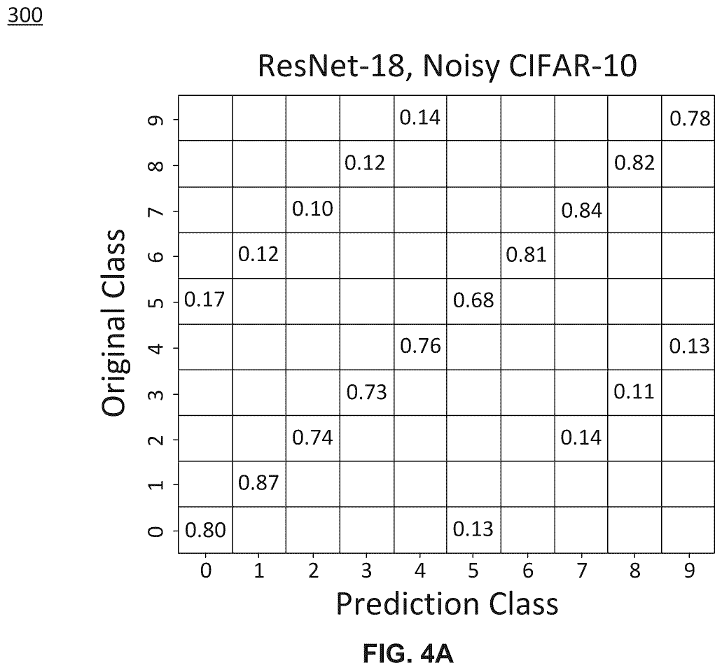

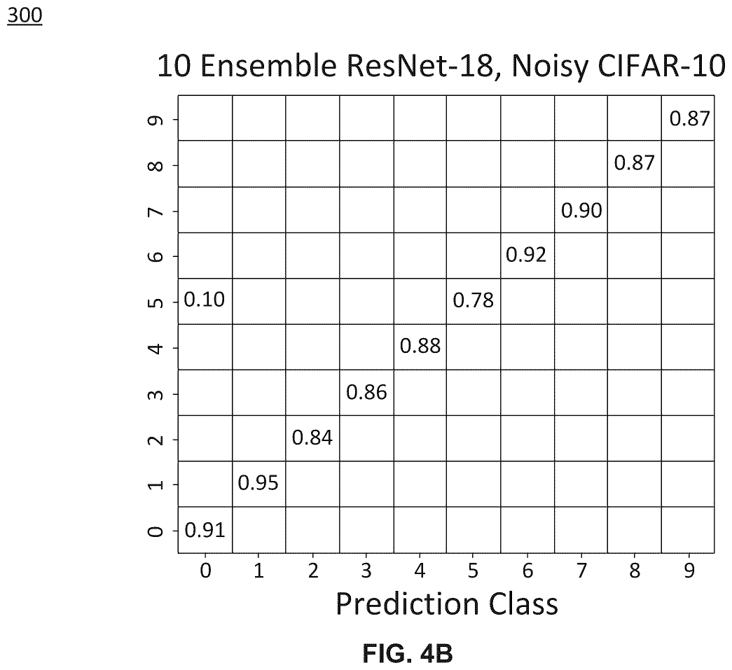

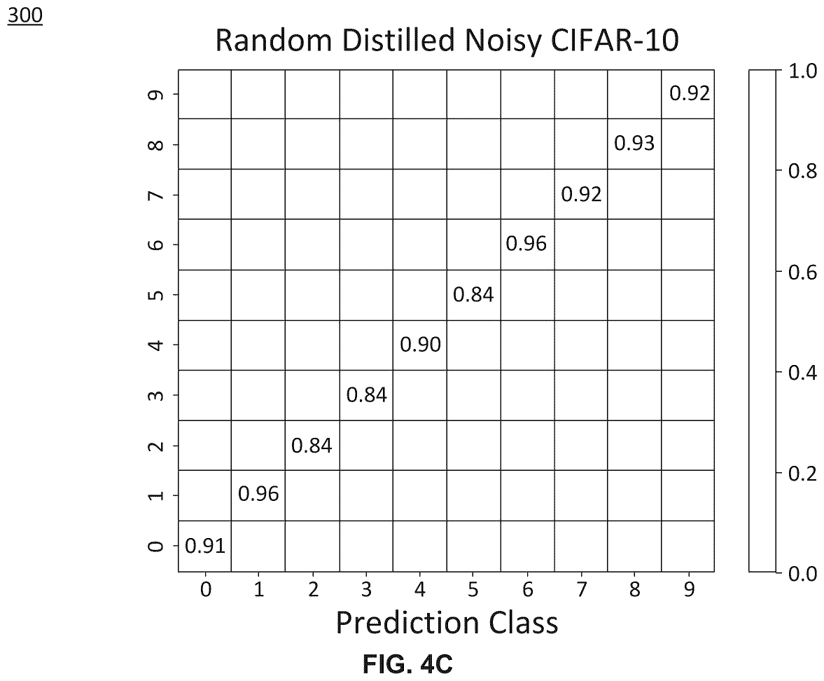

Additional embodiments described herein disclose systems and methods for knowledge distillation, in which each example is labeled by a random teacher network selected from a fixed pool (see FIG. 4C). Quantitative aspects of the sample complexity of teaching and learning in such configurations is further discussed herein, for both ensemble-distillation and distillation from a random teacher.

Knowledge Distillation for deep learning can provide a number of practical benefits for various machine learning tasks. The success of knowledge distillation may depend on soft labels of the teacher passing additional information on the input. In other words, as a teacher approaches approximation of Bayes class-probabilities, knowledge distillation may become possible. According to some embodiments, even when one or more teachers are far from the Bayes optimal prediction (i.e., when teachers are noisy samplers from the distribution), a student with low levels of noise may be identified via knowledge distillation.

According to some embodiments, statistical query algorithms may be leveraged to learn under noisy labels. For example, where one or more manually labeled images has become corrupt, either intentionally or inadvertently, one or more statistical query algorithms may be implemented to facilitate learning, particularly via the knowledge distillation for label noise robustness, according to the present disclosure.

For example, let [symbol] be the input space and [symbol] ={±1} be the label space (under certain assumptions most of the results may be extended to multiclass). A hypothesis class [symbol] may correspond to a class of functions from [symbol] to [symbol] . A learning algorithm [symbol] may take a sequence of m samples S∈( [symbol] × [symbol] )^{m} and output a hypothesis h: [symbol] → [symbol] . IT is denoted by [symbol] (S) the hypothesis that [symbol] outputs when observing the sample S. For some distribution [symbol] over [symbol] × [symbol] , the X marginal may be denoted as [symbol] with the Bayes optimal classifier as

$${f}_{𝒟}^{*} ( x ) := arg {max}_{y ∈ 𝒴} {ℙ}_{𝒟} ( y \vert x ) ,$$

assuming that ties are broken arbitrarily.

When [symbol] is a distribution where the label is not a deterministic function of the input, [symbol] may be considered a noisy version of some clean distribution [symbol] *, where each input is correctly labeled. It is thus assumed that the probability of seeing the correct label is greater than seeing an incorrect label. In other words, [symbol] * may have the same marginal distribution over

[symbol]

$$( i . e . , {D}_{𝒳} = {D}_{𝒳}^{*} ) ,$$

and may be labeled by the Bayes optimal classifier of [symbol] . Thus, sampling (x,y)˜ [symbol] may be represented by x˜ [symbol] and

$$y = {f}_{𝒟}^{*} ( x ) .$$

The “noise” of the distribution [symbol] may be denoted as

$$η𝒟 = := {ℙ}_{( x , y ) ∼ 𝒟} [ y \neq {f}_{𝒟}^{*} ( x ) ] .$$

A margin of the distribution may also be taken into account, this margin of distribution corresponding to a difference in probability between correct and incorrect labels for each example. For example, for some δ≥0, let γ_{δ}( [symbol] ) be the supremum over γ>0 such that the following Equation may be satisfied:

$${ℙ}_{x ∼ {𝒟}_{x}} [ {ℙ}_{𝒟} {f}_{𝒟}^{*} ( x \vert x ) < {max}_{y \neq {f}_{𝒟}^{*} ( x )} {ℙ}_{𝒟} {f}_{𝒟}^{*} ( y \vert x ) + γ ] \leq δ ecifically ,$$

the following may be denoted γ( [symbol] ):=γ₀( [symbol] ). Here, it is may be assumed that the input distribution has a strictly positive margin γ( [symbol] )>0, such that for every example the probability of having a correct label is greater than the probability of having an incorrect label. One objective for this setting is to approximate the Bayes optimal classifier of [symbol] . In other words, the aim is to minimize the 0-1 loss on a clean distribution [symbol] * in accordance with the Equation 1 below.

$${ℒ}_{𝒟} * ( h ) := {ℙ}_{( x , y ) ∼ 𝒟} [ h ( x ) \neq {f}_{𝒟}^{*} ( x ) ] = {ℙ}_{( x , y ) ∼ 𝒟} [ h ( x ) \neq y ] \qquad ( 1$$

In this way, the learning algorithm may have access to samples from the noisy distribution [symbol] , but may achieve good loss on the clean distribution [symbol] *. As used herein, the term “learner” is defined in this setting to be an algorithm that minimizes Eqn. 1 using a finite number of samples. The following definition is provided to aid in implementation of embodiments of the present disclosure.

Definition 1: For some learning algorithm [symbol] and some distribution [symbol] over [symbol] × [symbol] , [symbol] is a learner for [symbol] if there exists a function m: (0,1)→ [symbol] such that for every ε∈(0,1), taking m≥m(ε), [symbol] ( [symbol] ( [symbol] ))≤ε is obtained.

In this case, m(⋅) may correspond to a sample complexity of [symbol] with respect to [symbol] . Additionally, for some class [symbol] of distributions over [symbol] × [symbol] , we say that [symbol] is a learner for [symbol] if there is some m(⋅) such that [symbol] is a learner with sample complexity m(⋅) for every [symbol] ∈ [symbol] .

The present definition of a learner is similar to the notion of an asymptotically consistent estimator, but with explicit accounting for sample complexity. For example, consider agnostic learning using the Empirical Risk Minimization (ERM) rule, namely: ERM_{H}(S)= [symbol] L_{S}(h). For some hypothesis class [symbol] and some margin >0, let [symbol] ( [symbol] ,γ) be the class of distributions such that for every [symbol] ∈ [symbol] ( [symbol] ,γ) we have γ [symbol] ≥γ and

$${f}_{𝒟}^{*} ∈ ℋ .$$

Namely, [symbol] ( [symbol] ,γ) is the class of distributions with margin for which the Bayes optimal classifier comes from [symbol] . The following theorem states that a finite VC-dimension and a non-zero margin form a sufficient condition for learnability with noise.

Theorem 2: There exists a constant C>0 such that for every hypothesis class [symbol] with VC( [symbol] )<∞, ERM_{H} is a “learner” for [symbol] ( [symbol] ,γ) with sample complexity

$$m ( ε ) = C \frac{VC ( ℋ ) + log ( \frac{1}{ε} )}{{ε}^{2} {γ}^{2}} .$$

One focus of Theorem 2 is the following lemma, showing that the margin assumption connects a small relative error, with respect to [symbol] , to a small absolute error with respect to [symbol] *.

Lemma 3. Fix some distribution [symbol] , and let h* represent the Bayes optimal classifier for [symbol] . Assume that γ_{δ}( [symbol] )>0. Then, for every h such that [symbol] (h)≤ [symbol] (h*)+ε, it holds that

$${ℒ}_{𝒟} * ( h ) \leq \frac{ε}{{γ}_{δ} ( 𝒟 ) + δ} .$$

Combining this lemma with the Fundamental Theorem of Learning Theory yields Theorem 2. From Theorem 2, it may be determined that, given more samples than the VC-dimension (e.g., corresponding to the number of parameters), learning may be possible. However, complex classifiers with large VC-dimension such as neural networks may be trained in the overparameterized regime, where the number of parameters exceeds the number of samples. In this regime, the bound of Theorem 2 becomes vacuous, however, this does not rule out the possibility of distribution-dependent sample complexity bounds using other measures of complexity (e.g., Rademacher complexity).

### Conditional Samplers

As previously mentioned, neural networks trained on noisy data may replicate the noise to unseen samples as well, thereby behaving like samplers from the noisy distribution. Thus, a formal definition of a conditional sampler according to the present disclosure is provided for a distribution [symbol] . For a learning algorithm [symbol] , a number m∈ [symbol] and a distribution [symbol] over [symbol] × [symbol] , define the distribution [symbol] ( [symbol] ^{m}) over [symbol] × [symbol] , where (x,y)˜ [symbol] ( [symbol] ^{m}) is given by sampling S˜ [symbol] ^{m} sampling x˜ [symbol] ₓ and setting y= [symbol] (S)(x). Namely, [symbol] ( [symbol] ^{m}) is the distribution given by (re)-labeling [symbol] using a hypothesis generated by [symbol] when observing a random sample of size m. Using these notations, a sampler algorithm for the distribution [symbol] may be defined as follows:

Definition 4: For a learning algorithm [symbol] and a distribution [symbol] over [symbol] × [symbol] , [symbol] is a conditional sampler for [symbol] where there exists \tilde{m}: (0,1)→ [symbol] such that for every ε∈(0,1) taking m≥\tilde{m}(ε)TV( [symbol] ( [symbol] ^{m}), [symbol] )≤ε, is obtained, where TV represents the Total Variation Distance. Then, \tilde{m} corresponds to the sample complexity of [symbol] with respect to [symbol] . Additionally, for some class [symbol] of distributions over [symbol] × [symbol] , [symbol] may be determined as a sampler for [symbol] if there exists m(⋅) such that [symbol] is a conditional sampler with sample complexity \tilde{m}(⋅) for each [symbol] ∈ [symbol] .

A sampler for [symbol] may therefore correspond to an algorithm that generates a distribution similar to [symbol] (the noisy input distribution) when labeling new samples. One example for a conditional sampler is the 1-Nearest-Neighbor algorithm: since 1-NN outputs the (possibly corrupted) label of the closest neighbor, its prediction may behave like sampling from [symbol] (y|x). FIGS. 3B-3C show results highlighting that neural networks may behave similarly to conditional samplers when trained on a noisy version of, for example, the CIFAR-10 dataset.

FIG. 4A illustrates an example confusion matrix showing how a trained model ƒ behaves as a conditional sampler, in accordance with one or more aspects of the present disclosure. FIG. 4B illustrates an example confusion matrix corresponding to the execution of an ensemble of samplers at inference time, in accordance with one or more aspects of the present disclosure. FIG. 4C illustrates an example confusion matrix corresponding to the implementation of a distillation algorithm in which each sample is labeled by a random teacher from a fixed set of teachers, in accordance with one or more aspects of the present disclosure.

Given the above definition, it can be shown that, instead of approximating the Bayes optimal prediction, a conditional sampler may preserve a noise rate of the original distribution.

Lemma 5. Let [symbol] be a sampler [symbol] with sample complexity \tilde{m}. Then, for m≥\tilde{m}(ε),

$$η ( 𝒟 ) - ε \leq {𝔼}_{S ∼ {𝒟}^{m}} {L}_{𝒟} * ( 𝒜 ( S ) ) \leq η ( 𝒟 ) + ε$$

While a conditional sampler for [symbol] may not be a suitable learner (e.g., in the sense of Definition 1 above), a conditional sampler for [symbol] may have favorable properties. For example, such a conditional sampler may take significantly fewer samples to obtain a sampler than it would take to obtain a learner, hence rendering conditional samplers more suitable for an overparameterized regime. According to some embodiments, a conditional sampler may be obtained using only a single example from the distribution. In contrast, obtaining a learner for the same distribution may involve an arbitrarily large number of samples. For example, fixing b∈{±1} and γ∈(0,1), and letting [symbol] _{b} represent the distributions concentrated on a single sample (x,y), with label γ∈{±1} such that

$${ℙ}_{{𝒟}_{b}} ( y = 1 ) = \frac{1 + b γ}{2} .$$

To obtain a conditional sampler from [symbol] _{b} a single sample (x, y) may be used, and return the constant function y. To find the Bayes optimal for the distribution [symbol] _{b}, on the other hand, any algorithm may take at least

$$Ω ( \frac{1}{{γ}^{2}} )$$

samples.

Theorem 6. For every M>0, there exists a class of distributions [symbol] _{M} such that:

There exists a sampler for [symbol] _{M} with sample complexity \tilde{m}≡1 and any learner for [symbol] _{M} has sample complexity satisfying m(⅛)>=M.

Conditional samplers may be more sample efficient than learners, but may incur the cost of providing noisy predictions. While conditional samplers are in and of themselves generally not suitable as classifiers, they may still perform as teachers. That is, conditional samplers may be used to label a large unlabeled dataset and to train a student classifier on this new dataset. This process, as noted above, may be referred to as knowledge distillation. The following definition captures the notion of a (good) teacher.

Definition 7. For a learning algorithm [symbol] , a distribution [symbol] over [symbol] × [symbol] , [symbol] may be a teacher for [symbol] where there exists a function \tilde{m}: (0,1)²→ [symbol] such that for every ε,τ∈(0,1), taking m≥\tilde{m}(ε,τ) the following holds:

$$1. {ℒ}_{\_} ( 𝒟 \hat{} \text{*)} ( f\_𝒜 ( 𝒟 \hat{} m ) *= ℙ\_ ( x ∼ 𝒟 ) [ f\_𝒟 \hat{} * ( x ) \neq f\_𝒜 ( 𝒟 \hat{} m ) \hat{} * ( x ) ] \leq ε$$

$$2. {γ}_{ε} ( 𝒜 ( {𝒟}^{m} ) ) \geq γ ( 𝒟 ) - τ$$

Additionally, for some class [symbol] of distributions over [symbol] × [symbol] , [symbol] may be a teacher for [symbol] where there is some m(⋅,⋅) such that [symbol] is a teacher with sample complexity m(⋅,⋅) for every [symbol] ∈ [symbol] .

The first condition in the above definition means that the Bayes optimal of the original distribution and the distribution induced by the teacher are close. The second condition means that the probability mass of low margin samples from the distribution labeled by the teacher is small. An algorithm satisfying Definition 7 may correspond to a “good” teacher because the distribution it induces is “similar” to the original distribution. Hence, if the student finds a good hypothesis on the teacher induced distribution, its hypothesis may also be considered “good” with respect to the original distribution.

When and how teachers may be used for knowledge distillation is described in greater detail below, for example, with regard to giving guarantees for obtaining students with a small error with respect to the clean distribution [symbol] *. However, for clarity conditional samplers as teachers are described.

Theorem 8. Let [symbol] be a sampler for [symbol] with sample complexity m(⋅) and margin γ. Then, [symbol] is a teacher for [symbol] with sample complexity

$$\tilde{m} ( ε , τ ) = m ( ε \cdot min ( \frac{τ}{2} , γ ) ) .$$

Thus, given an example with probability mass p, the “cost” (in terms of TV) of flipping the sample's label with respect to the Bayes optimal

$${f}_{𝒟}^{*}$$

is at least p·γ. Since the TV “budget” may be limited by εγ, only a probability mass of ε of the distribution may be flipped.

Learners may also be qualified as “good” teachers, for at least the reason that learners approximate the Bayes optimal classifier, and hence can be used to train students to similarly imitate the Bayes classifier.

Theorem 9. Let [symbol] be a learner for [symbol] with sample complexity m(⋅). Then, [symbol] is a teacher for [symbol] with sample complexity

$$\tilde{m} ( ε , τ ) = m ( \frac{ε ( 1 - γ ( 𝒟 ) + τ )}{2} ) .$$

Thus, Theorem 8 and Theorem 9 show that, to some extent, a teacher is an “interpolation” between a conditional sampler and a learner.

Teachers (and in particular, conditional samplers) may be used to find suitable learners. As previously noted, an ensemble of teachers can be used to obtain a learner by outputting the majority vote of the ensemble, e.g., an output having a highest score as calculated among the ensemble of teachers.

Using an ensemble of teachers to label a new set of unlabeled examples (i.e., performing knowledge distillation) can guarantee that a student with small loss is identified, assuming that the Bayes optimal classifier comes from the hypothesis class learned by the student. Such process may be advantageous for at least the reasons that it may reduce the computational cost of running the ensemble at inference time, and may also enable using a different hypothesis class for the student (e.g., when using a student network of smaller size).

Knowledge distillation can also be achieved by labeling examples using a teacher that may be randomly selected from a fixed (e.g., predetermined) set of teachers, a method that has some computational benefits (e.g., improved resource usage) at training time.

An ensemble of teachers can be used to obtain accurate predictions with respect to the Bayes optimal predictor. For example, given some k samples S₁, . . . , Sₖ˜ [symbol] ^{m}, each one of size m, a learning algorithm [symbol] may be executed to obtain k different hypothesis h₁, . . . , hₖ, where hᵢ: = [symbol] (Sᵢ). The ensemble hypothesis may output the majority vote of the ensemble members (as noted above) in accordance with the following relationship:

$${h}_{e n s} ( x ) = {arg max}_{y ϵ𝒴} {\sum }_{i} 1 \{ {h}_{i} ( x ) = y \}$$

The notation [symbol] ₑₙₛ(S₁ . . . , Sₖ): =hₑₙₛ may be used to denote this ensemble hypotheses, with the following Theorem showing that the ensemble hypothesis may have reasonable loss on average, when using a large enough ensemble of teachers:

Theorem 10. Assume that [symbol] is a teacher for some distribution [symbol] with complexity \tilde{m}. Then, for all ε∈(0,1), taking

$$m \geq \tilde{m} ( \frac{ε}{3} , \frac{γ ( 𝒟 )}{2} ) and \frac{16 log ( \frac{3}{ε} )}{{γ ( 𝒟 )}^{2}} ,$$

the following relationship is obtained:

$${𝔼}_{{S}_{1} , … , {S}_{k} ∼ {𝒟}^{m}} {L}_{{𝒟}^{*}} ( {𝒜}_{e n s} ( {S}_{1} … , {S}_{k} ) ) \leq ε$$

For some εϵ [symbol] , let yᵢ be the prediction of the i-th teacher, y̅ and let be the average of the predictions, namely

$$\overline{y} = \frac{1}{k} {\sum }_{i} {y}_{i} .$$

Thus, hₑₙₛ=sign(y̅), and additionally [symbol] [y|x]. Now, because [symbol] is a teacher [symbol] [y|x]≈ [symbol] [y|x] (with high probability over the choice of x), and by concentration bounds this may imply with high probability that hₑₙₛ(x) provides the Bayes optimal prediction (i.e., h_ens(x)=ƒ_ [symbol] \hat{ }*(x)).

Thus, Theorem 10 can be considered to show that if [symbol] is a teacher for [symbol] , then [symbol] ₑₙₛ with k≥\tilde{Ω}(1/ [symbol] )² is a learner for [symbol] . It is noted that \tilde{Ω} is used to hide constant and logarithmic factors. More generally, if a teacher for some distribution [symbol] has positive margin, this may imply that there exists a learner for the same distribution.

The inverse of the preceding statement gives another interesting result, i.e., if no algorithm can learn some problem, then getting a teacher (or sampler) may also be difficult. For example, let [symbol] be a class of distributions over [symbol] × [symbol] such that for all [symbol] ∈ [symbol] it holds that γ( [symbol] )≥γ. Then, if there is no learner for [symbol] , there may not be a teacher or sampler for [symbol] . Additionally, a similar result holds for problems which are computationally intensive (i.e., difficult) to learn. That is, if there is no learner for [symbol] that runs in polynomial time, then there is no poly-time teacher or sampler for [symbol] . Observe that the condition that γ( [symbol] )≥γ for all for all [symbol] ∈ [symbol] in the previous statement is necessary. Indeed, taking

$$𝒫 = {U}_{M = 1}^{∞} ,$$

where [symbol] _{M} is the distribution class that may be guaranteed by Theorem 6, gives a class [symbol] such that there is a sampler for [symbol] with sample complexity \tilde{m}≡1, but there is no learner for [symbol] .

An ensemble of k=\tilde{Ω}(γ⁻²) teachers may provide a classifier approximating the Bayes optimal predictor. This, however, may incur a k factor in computational cost at inference time. To prevent this, embodiments discussed herein may implement the ensemble to label new unlabeled data, and train a new classifier to imitate the ensemble. This may aid in shifting the computational burden from inference time to training time, thereby more efficiently using resources.

For example, for a class [symbol] , an Ensemble-Pseudo-Labeling (EPL) algorithm in accordance with an embodiment may be provided as follows:

1. For some k, m∈ [symbol] , sample S₁, . . . , Sₖ˜ [symbol] ^{m}.

2. Run [symbol] on S₁, . . . , Sₖ, and let hₑₙₛ= [symbol] ₑₙₛ [symbol] (S [symbol] ₁, . . ., Sₖ).

3. Take S′ to be a set of m′ unlabeled samples sampled from [symbol] , and label it using hₑₙₛ.

4. Denote by \tilde{S} the pseudo-labeled set. Run [symbol] on the set \tilde{S} and return

$$h := ER {M}_{ℋ} ( \tilde{S} ) .$$

For at least the reason that hₑₙₛ approximates the Bayes optimal classifier (see Theorem 10), the labels for the new dataset S′ may be mostly correct. In other words, the pseudo-labeled set \tilde{S} comes from a distribution that is close to the clean distribution [symbol] *. When using pseudo-labels, it may be sufficient use unlabeled data, which may be readily available, so \tilde{S} can be much larger than an original labeled dataset. In such cases, the overparameterized regime may be set aside, so [symbol] is guaranteed to achieve good performance by standard VC bounds. This observation is captured in Theorem 11:

Theorem 11. For a hypothesis class [symbol] with VC( [symbol] )<∞, and let [symbol] ϵ [symbol] ( [symbol] ,γ) for some γ>0. Let [symbol] be a teacher for [symbol] with distributional sample complexity \tilde{m}. Then, there exists a constant C>0 such that for every ε∈(0,1), running the EPL algorithm with parameters

$$m \geq \tilde{m} ( \frac{ε}{12} , \frac{γ}{2} ) , {m}^{′} \geq C \frac{VC ( ℋ ) + log ( \frac{1}{ε} )}{{ε}^{2}} and k \geq \frac{16 log ( \frac{12}{ε} )}{{γ}^{2}}$$

returns a hypothesis h satisfying

$${𝔼}_{{S}_{1} , … , {S}_{k} , \tilde{S}} {L}_{{D}^{*}} ( h ) \leq ε .$$

While the EPL algorithm may shift the computation cost from inference to training, there remains a k factor for labeling each sample. Therefore, according to some embodiments, samples may be labeled by selecting a random classifier from the ensemble. Then, only one classifier is run per sample. For example, from an ensemble of teachers, the output of a single, randomly selected teacher, may be output from the ensemble and provided to the classifier. Thus, the Random-Pseudo-Labeling (RPL) may be defined similarly to EPL, except that for each sample x in the unlabeled dataset S′, h˜{h₁, . . . , hₖ,} is selected and x is labeled by h(x).

S′ may come from a distribution [symbol] , defined by sampling x˜ [symbol] and sampling y such that [symbol] [y|x]= [symbol] _{i˜[k]}[hᵢ(x)]. Based on the properties of the teacher, using concentration arguments as in Theorem 10, the distribution [symbol] is close to the noisy distribution [symbol] . However, as mentioned before, the advantage of using S′˜ [symbol] is that a much larger set of unlabeled data may be used, in which case the result of Theorem 2 can be applied to show that the above algorithm finds a hypothesis with good error. This is stated in the following result:

Theorem 12. For hypothesis class [symbol] with VC( [symbol] )<∞. Let [symbol] ϵ [symbol] ( [symbol] ,γ) for γ>0. Let [symbol] be a teacher for [symbol] with distributional sample complexity \tilde{m}. Then, there exists a constant C>0 such that for every ε∈(0.1), running the RPL algorithm with parameters

$$m \geq \tilde{m} ( \frac{εγ}{54} , \frac{γ}{2} ) , {m}^{′} \geq C \frac{VC ( ℋ ) + log ( {ε}^{- 1} {γ}^{- 1} )}{{ε}^{2} {γ}^{2}} and k \geq \frac{128 log ( 36 {ε}^{- 1} {γ}^{- 1} )}{{γ}^{2}}$$

returns h satisfying

$${𝔼}_{{S}_{1} , … , {S}_{k} , \tilde{S}} {L}_{{D}^{*}} ( h ) \leq ε$$

Compare the sample complexity of the above Theorem 12 with the sample complexity achieved by the EPL algorithm, stated in Theorem 11. The gain from using the RPL algorithm may not be clear, as it increases the number of unlabeled data by a factor of 1/ [symbol] (and also might increase the number of labeled examples). Thus, a dataset labeled by a random classifier may be much noisier than a dataset labeled by the ensemble, and hence more examples may be desirable in order to learn. Note, that because k≥\tilde{Ω}1/ [symbol] , the randomized labeling takes 1/k compute per sample relative to the ensemble labeling, it will, however, label an order of k times more samples.

There may be computational benefits to using the random teacher approach, for example, it may allow the training and labeling to be performed in parallel without a significant increase in computational processing (e.g., 2 GPU cores may be sufficient to train in parallel without significant, if any loss of time). On the other hand, labeling a dataset using the ensemble may involve either increasing the computation by k (applying parallelism), or otherwise waiting until the full dataset is labeled before starting the knowledge distillation process.

According to embodiments described herein, the gain from ensemble labeling over random labeling, as captured by the final accuracy of the trained student, may not be significant enough to favor one over the other. This can be seen in the results shown at Table 1 below.

TABLE 1

| Experiment | Test Accuracy ± std |
|---|---|
| One Teacher | 0.868 ± 5e−3 |
| 5 Random Teachers | 0.898 ± 2e−3 |
| 10 Random Teachers | 0.900 ± 2e−3 |
| 5 Teacher Ensemble | 0.899 ± 2e−3 |
| 10 Teacher Ensemble | 0.902 ± 1e−3 |
| 10-Ensemble Inference | 0.878 |
| 10-Teacher Clean Ens. | 0.934 ± 0.8e−3 |
| Teacher Accuracy | 0.813 ± 4.7e−2 |

However, as further noted from Table 1, according to some particular cases (e.g., under further assumptions on the data distribution and/or the optimization algorithm), it may be preferable to use the RPL algorithm.

Conditional samplers as teachers may be used for knowledge distillation, for example, by generating students which may approximate the Bayes optimal prediction. As discussed below, some known algorithms can be implemented as conditional samplers and/or teachers.

According to some embodiments, a k-Nearest-Neighbor (kNN) algorithm may be implemented as a teacher where an underlying distribution has some Lipschitz property. With regard to the kNN algorithm, Lipschitz classes of functions (e.g., linear functions, kernels, and neural networks) may be analyzed to show that when the data is well-clustered, the kNN algorithm can be a teacher. Further, a sample complexity for the conditional samplers or teachers may be lower than a sample complexity for learning, and may be configured as desired.

Considering the Nearest-Neighbor, for a set S={(x₁, y₁), . . . , (xₘ, yₘ)}⊆X×Y, [symbol] ={x₁, . . . , xₘ}. A metric d may be fixed over the space [symbol] . According to some embodiments, it may be assumed that the metric space ( [symbol] ,d) satisfies the Heine-Borel property—that is, every closed and bounded set in [symbol] is compact. Specifically, the Heine-Borel property holds for [symbol] ⁿ where d is induced by some norm.

For some finite set S⊆X×Y, and some x∈X, denote

$$d ( x , S ) := {min}_{{x}^{′} ∈ {S}_{x}} d ( x , {x}^{′} ) d π ( x , S ) := arg {min}_{( {x}^{′} , {y}^{′} ) ∈ S} d ( x , {x}^{′} ) .$$

The set [symbol] k−π(x,S [symbol] )⊆S may be defined to be the set of k points in S that are closest to x. That is, k−π(x,S) is a set of size k such that for any (\tilde{x}, \tilde{y})∈S k−π(x,S), it holds that d(x,x′)≤d(x,\tilde{x}). If there are multiple choices for such set, one may be selected arbitrarily, or alternatively via any suitable selection method. For some distribution [symbol] , it may be determined that [symbol] is λ-Lipschitz if for all x,x′∈supp( [symbol] ) and y∈ [symbol] it holds that | [symbol] [y|x]− [symbol] [y|x′]|≤λd(x,x′).

For some odd k≥1, define [symbol] _{k-NN}(S)(x): = [symbol] |(x′,y′)ϵk−π(x,S),y′=ŷ|, i.e. [symbol] _{k-NN}(S) is a k-nearest-neighbor algorithm over sample S. [symbol] _{1-NN}(S) is a conditional sampler. The distributional sample complexity of [symbol] _{1-NN} may thus depend on the number of ε balls that can cover a 1−δ mass of the distribution. Given such cover, with a large enough sample, a candidate sample may be found in each of the balls that have non-negligible mass. In that case, if the distribution of labels does not change significantly in each ball, [symbol] _{1-NN} may be determined to be a conditional sampler.

Theorem 13. Let [symbol] be some λ-Lipschitz distribution. Then, [symbol] _{1-NN} is a conditional sampler for [symbol] .

A k-Nearest-Neighbor algorithm for any odd k≥1 is now described. Similarly to the analysis of the 1-Nearest-Neighbor case, a large enough sample may be used to obtain at least k candidates in each of the ε-ball covering the distribution. In this case, the prediction of the k-Nearest-Neighbor algorithm may correspond to the majority vote over the k neighbors in each ball. This will grow closer to the Bayes optimal prediction as k grows, and therefore k-Nearest-Neighbor algorithm may be determined as not a conditional sampler for k>1, however, the model may be determined as a teacher.

Theorem 14. [symbol] may be some λ-Lipschitz distribution. Then, [symbol] _{k-NN} may be a teacher for [symbol] .

The core argument for proving Theorem 14, beyond the covering argument used in the 1-Nearest-Neighbor case, relies on using a variant of Condorcet's Jury (CJT) Theorem. The theorem generally states that the accuracy of the majority vote of a set of predictors is better than the average accuracy of the individual predictors. In the k-Nearest-Neighbor case, each of the k candidates casts a “vote”, and using CJT, a demonstrated improvement over the 1-Nearest-Neighbor prediction, which is already a sampler (and hence a teacher), may be observed. This may work for any k≥1, and k may be of any desired size, which is in contrast to obtaining a learner.

Example: Limited Memory 1-Nearest Neighbor. An illustrative example is provided where applying the knowledge distillation methods studied above result in a low-error student classifier, while at the same time using the same learning algorithm on the labeled data alone should maintain high levels of noise in the prediction. For purposes of this example, [symbol] ={0.1}ⁿ is assumed to simplify the analysis, but similar arguments can be applied to the case where [symbol] = [symbol] ⁿ, for example.

According to this example, a 1-Nearest-Neighbor (1-NN) algorithm is implemented for the teacher. However, the 1-NN is not used a student, since the VC-dimension of 1-NN classifiers may be infinite, thereby introducing certain difficulties. Thus, a similar hypothesis class of 1-NN with limited memory is implemented as the student. [symbol] _{b} corresponds to the class of 1-NN predictors with memory of size b. That is, for every hϵ [symbol] _{b} there is some S⊆X×Y such that S can be stored using b bits of memory, and for every xϵ [symbol] we have h(x)=ŷ, where ŷ is the label of the closest neighbour to x in S, namely (\hat{x},ŷ)=π(x,S). Thus, [symbol] _{b} is a finite class of size 2^{b}, and therefore VC( [symbol] _{b})≤log(| [symbol] _{b}|)=b.

Moving on with the example, [symbol] may correspond to a distribution such that

$${f}_{𝒟}^{*} ϵ {ℋ}_{b} .$$

Assume a labeled dataset of size km is drawn from [symbol] (k subsets of size m), and that km·n<n (that is, that the teacher is trained in the overparameterized regime). In this case, [symbol] _{1-NN} may be implemented as the algorithm for the teacher, and [symbol] as the student. Assuming the teacher is trained in the overparameterized regime, there can be many ERM solutions, and one should be chosen, so simply taking [symbol] may not be sufficient. Thus, in the overparameterized regime, [symbol] _{1-NN} may be used.

Indeed, based on the above it follows that both the EPL and the RPL algorithms may yield a student which approximates the Bayes optimal predictor. Additionally, according to Theorem 13, using [symbol] _{1-NN} over the entire training set may yield a sampler, which can be far from the Bayes optimal predictor (see Lemma 5 above).

According to some embodiments a k-Nearest-Neighbor (k-NN) may be used instead of a 1-NN to obtain a classifier that approximates the Bayes optimal prediction, where k is sufficiently large. However, in practice, “black-box” algorithms such as neural networks can behave like a 1-NN. In such cases, knowledge distillation can take an algorithm that behaves like a 1-NN and convert it into an algorithm that behaves like a k-NN, without knowledge of the internals of the algorithm, and without suffering additional computational costs at inference time.

According to some embodiments, infinite-width neural-network with weights of bounded norm may be implemented in the teacher/student context. A ReLU network of width k and depth 2 may be defined as:

$${h}_{θ} ( x ) = {\sum }_{i = 1}^{k} {W}_{i}^{( 2 )} σ ( 〈 {w}_{i}^{( 1 )} , x 〉 + {b}_{i}^{( 1 )} ) + {b}^{( 2 )}$$

where θ=(k,W⁽¹⁾), W\hat{ }((2)) [symbol] ,b [symbol] \hat{ }((1)) [symbol] ,b [symbol] \hat{ }((2))) and σ is the ReLU activation, namely σ(x)=max {x,0}. The Euclidean norm of non-biased weights may be considered as:

$$C ( θ ) = \frac{1}{2} {\sum }_{i = 1}^{k} ( {( {w}_{i}^{( 2 )} )}^{2} + {‖ {w}_{i}^{( 1 )} ‖}_{2}^{2} )$$

A sample S⊆ [symbol] × [symbol] may be fitted with a network h₇₄ with C(θ) acting as regularization. Namely, using the following objective function:

$$R ( S ) = {inf}_{θ} C ( θ ) ch that {h}_{θ} ( x ) = y for all ( x , y ) ϵ S .$$

In the one-dimensional case, i.e. when [symbol] = [symbol] , R(S) gives the linear spline interpolation of the data points. Namely, let \hat{θ}: =R(S), and assume that S={(x₁,y₁), . . . , (xₘ,yₘ)} is sorted such that x₁<x₂< . . . <xₘ (assuming there are no repeated samples). Then, for every iϵ[m] and for all x∈[x₁,x₁₊₁] it holds that:

$${h}_{\hat{θ}} ( x ) = {y}_{i} + \frac{{y}_{i + 1} - {y}_{i}}{( {x}_{i + 1} - {x}_{i} ) ( x - {x}_{i} )}$$

In this case, for all x∈[x₁, xₘ], sign h_{\hat{θ}}(x)=1-NN(S)(x), so training a network with bounded-norm weights (and unbounded width) may be considered to behave like nearest neighbor classification over the range covered by the sample. Using this, ReLU networks in this setting may correspond to samplers, as shown below.

Theorem 15. Let [symbol] be the algorithm that takes a sample S and returns a function h such that h(x)=sign [symbol] (h [symbol] _θ\hat{ } (x), for θ\hat{ }=R(S). Let [symbol] be a continuous λ-Lipschitz distribution. Then, [symbol] may correspond to a conditional sampler for [symbol] . A continuous distribution over [symbol] may be defined to be any distribution such that the function θ(a)= [symbol] [x≥a] is continuous. In this case, with probability of 1 there may not be any repeated examples in S, therefore avoiding the case where R(S) is not well-defined.

The above shows that when the size of the network is not limited (i.e., in the overparameterized regime), and use the weights' norm as regularization, the resulting algorithm may correspond to a conditional sampler. Using such regularization is generally desired for this result, because simply choosing some network that fits the data (rather than choosing the network with minimal norm), may not always yield a conditional sampler. Indeed, a ReLU network h_{θ} may be constructed that outputs a constant value (e.g., 1) for all x∈ [symbol] , outside of infinitesimally small neighborhoods of the points of S, where h_{θ} interpolates the data (namely, h_{θ} is constant with very narrow “spikes” towards the correct labels of the examples in the sample). Thus, on new points h_{θ} may evaluate to 1 with high probability, so it may not behave like a conditional sampler.

Cases greater than one-dimension may involve an understanding of high-dimensional geometry of the function returned by R(S). Some technical tools for understanding the multivariate version of the above problem may be used, for example, solving R(S) may be equivalent to minimizing a specific norm in function-space, which controls the complexity of the learned function. Among other things, controlling this norm may prevent a “spiking” behavior as described above.

Under certain clustering assumptions, many learning methods can be implemented as teachers. For another example, a simplified case of a distribution supported on a finite set is discussed. The following theorem shows that when the hypothesis class shatters the support of the distribution, [symbol] is a teacher with sample complexity Õ(k/ε).

### Theorem 16

Fix some hypothesis class [symbol] , and let [symbol] be some distribution over [symbol] × [symbol] such that |supp( [symbol] )|=k≤VC( [symbol] ) and the support of [symbol] is shattered. Then, [symbol] is a teacher with sample complexity

$$\tilde{m} ( ε , τ ) = \frac{2 k log ( 2 k / ε )}{ε} .$$

Contrast this with Theorem 2, where it was shown that where VC( [symbol] )=d, ERM corresponds to a learner with sample complexity

$$m ( ε ) = \tilde{O} ( \frac{VC ( ℋ )}{{ε}^{2} {γ ( 𝒟 )}^{2}} ) .$$

This shows that sampling can be achieved in this case without a dependence on 1/γ², as would be needed in order to get a learner. In fact, Theorem 6 shows that the dependence on 1/γ² in the sample complexity of a learner cannot be avoided.

More generally, according to Theorem 16, [symbol] may correspond to a well-clustered in k balls of small radius (similar to a Mixture of Gaussians with low variance). In this case, L-Lipschitz hypothesis classes, defined as follows may be considered.

Definition 17. A hypothesis class [symbol] is L-Lipschitz if for every h∈ [symbol] there exists some ĥ: [symbol] → [symbol] such that ĥ is L-Lipschitz and h(x)=sign ĥ(x) for all x∈ [symbol] .

A large family of learning methods such as bounded norm linear classifiers, kernel Machines, and shallow neural networks with Lipschitz activations (e.g., ReLU) may correspond to Lipschitz classes. For learning L-Lipschitz classes, the ERM rule with respect to the hinge-loss (over the real-valued output) instead of the zero-one loss may be considered. Namely, define

$$E R {M}_{ℋ}^{h i n g e} ( S ) = arg {min}_{h ∈ ℋ} {𝔼}_{( x , y )} [ {ℓ}_{h i n g e} ( y , \hat{h} ( x ) ) ] ,$$

where [symbol] _hinge (y,ŷ=max (1−yŷ,0)). The hinge-loss may then be used as it is often the case that the output of a real-valued hypothesis separates the data with some margin be used. Indeed, since the zero-one loss is invariant to scale, the L-Lipschitz assumption under the zero-one loss is meaningless, since the hypothesis can always be scaled down to satisfy any Lipschitz bound. So, when the data is well-clustered and the hypothesis class H is L-Lipschitz,

$$E R {M}_{ℋ}^{h i n g e}$$

is a teacher with sample complexity

$$\tilde{O} ( \frac{k}{{γ}^{2} ε} ) .$$

While this bound may depend on 1/γ², it may also improve the sample complexity of learning derived from Theorem 2.

Theorem 18. For L-Lipschitz class [symbol] , and some λ-Lipschitz distribution [symbol] such that

$$s upp ( {𝒟}_{X} ) ⊆ {⋃}_{i = 1}^{k} B ( {c}_{i} , r ) , where r = \frac{γ}{2 max ( λ , 3 L )}$$

and k≤VC( [symbol] ) so the set of balls B(cᵢ,r) can be shattered. Then,

$$E R {M}_{ℋ}^{h i n g e}$$

is a teacher, with sample complexity

$$\tilde{m} ( ε , τ ) = \tilde{O} ( \frac{k log ( 2 k / ε )}{{γ}^{2} ε} ) .$$

### Further Examples

Embodiments of the present disclosure have demonstrated that obtaining a conditional sampler (and thus a teacher) from a noisy distribution can be more sample efficient than obtaining a student. Furthermore, the disclosure has leveraged multiple independent teachers (e.g., an ensemble of teachers) to approximate the Bayes optimal classifier either via ensembling at inference time or via knowledge distillation on unlabeled data. The present examples relate to experimental evaluations, showing the benefit of using knowledge distillation when training on noisy data. As was previously described, teachers may be trained on entirely disjoint training sets, however, according to some embodiments it may be more effective to train the teachers on overlapping datasets, as well as training on same datasets with different random initialization.

As an example, teachers were trained with a ResNet-18 on CIFAR-10 with 20%-fixed and non-uniform label noise. According to the present example, the teachers achieved 81.3% test accuracy (see Table 1) and behaved closely to conditional samplers (see FIGS. 3B-3C).

The three methods discussed for using teachers to get learners are next compared: 1) Test time Ensembling; 2) Ensemble as distillation teacher and; 3) Random teacher distillation.

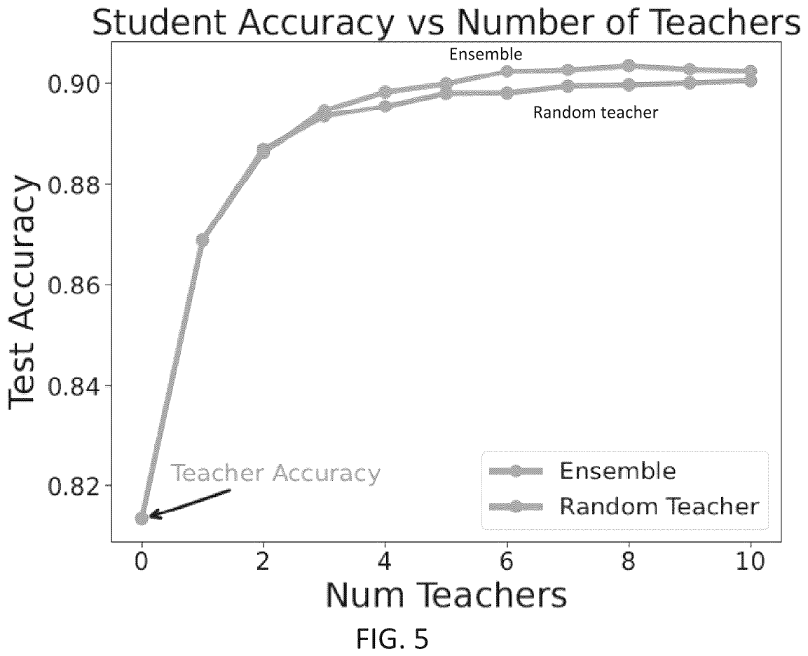

For knowledge distillation, a student network was trained on the CIFAR-5m, a large (5-million examples) dataset that resembles the CIFAR-10 dataset Bansal, where the labels are provided by the previously trained teachers. The results are shown in Table 1, where the reported accuracies are on the CIFAR-10 test data. Using an ensemble for inference may reduce the noise significantly, and may achieve test accuracy of 87.8% (versus 81.3% for a single teacher). When applying distillation, both random pseudo-labeling and ensemble pseudo-labeling further increase the test accuracy to about 90%. In addition, impact of the number of teachers on performance is considered. FIG. 5 illustrates a chart indicating test accuracy versus the number of teachers used, in accordance with one or more aspects of the present disclosure. As shown at FIG. 5 both random pseudo-labeling and ensemble majority may improve performance and accuracy when the number of teachers increases.

As autonomous vehicle navigation technology advances, more reliance is being placed on various types of machine learning/trained models to provide certain functionalities to host vehicle navigation systems, as well as related systems (e.g., drive data harvesting systems, mapping systems, etc.). For example, in some cases, such trained systems may assist in identifying certain types of conditions within an environment of a host vehicle (e.g., whether a door on a parked car is open or opening, whether a space between two parked cars is wide enough for a pedestrian to pass, etc.). Trained systems, however, can make more advanced inferences, such as a prediction of a planned trajectory ahead of a host vehicle, whether a partially obscured vehicle is likely to enter the path of the host vehicle, object detections based on fused sensor information, among many other examples. In most cases, trained systems “learn” during a training operation that includes providing training data sets to the model (e.g., a convolutional neural network, graph neural network, transformer-based network, etc.) and observing the inferences/predictions of the model provided as output. Where the model returns an incorrect response, adjustments can be made to the model (e.g., changing weights, etc.) to refine the model's inferences/predictions until a certain performance level (e.g., accuracy) is achieved.

Training data representing situations that are easy for the model to identify/characterize, etc. can be of value in developing a trained model with basic functionality. More advanced capabilities, however, may not be realized without data representing more difficult scenarios. Some of the most valuable training data may constitute “edge” cases that may represent unusual or hard-to-detect/characterize situations that challenge the capabilities of the model. While performance gains may be achieved by exposing the model to a fixed set of edge cases, the performance gains may be limited, as the number of edge cases is finite and such an approach does not take into account model performance to select or supplement training data. Further, such a fixed approach may also limit achievable efficiency during training. The presently disclosed systems are aimed at increasing the effectiveness and/or efficiency of model training by using model outputs generated during training as feedback for training data selection and/or training data generation such that newly selected or generated training data targets weaknesses of the model identified during training.

### Example Vehicle as an Environment for Trained Models

FIG. 1 illustrates a vehicle 100 including a safety and/or navigation system 200 (see also FIG. 2) in accordance with various aspects of the present disclosure. The vehicle 100 and the safety system 200 are exemplary in nature, and may thus be simplified for explanatory purposes. Locations of elements and relational distances (as discussed herein, the Figures are not to scale) are provided by way of example and not limitation.

The navigation system 200 may include various components depending on a desired implementation and/or application. For example, components of the navigation system 200 may be configured to facilitate navigation and/or control of the vehicle 100 while implementing various trained systems disclosed herein.

The vehicle 100 may include any type of vehicle (e.g., a road vehicle) and may be an autonomous vehicle (AV). An autonomous vehicle as used herein may include any level of automation (e.g. levels 0-5), including no automation (level 0) or full automation (level 5).

The trained systems may include those discussed herein as well as any other suitable trained systems for implementation in a vehicular environment. The trained systems may include one or more trained models trained as described herein and/or in any other suitable manner to facilitate execution of the described features.

### Adversarial Feedback-Based Training for Trained Models

According to further embodiments, and in conjunction with embodiments described above, an adversary of the disclosed trained system may be implemented to improve training of a student, for example, by improving efficiency and effectiveness. For example, when comparing output between a teacher and a student for a same input, the comparison results may indicate that the student has failed to produce correct output for a certain type or category of input (e.g., stop signs repeatedly identified as yield signs by the student). An adversary, as used herein, may then use the indication of incorrect output to identify weaknesses in accuracy or performance of the student model, and to take action to strengthen the student (e.g., refine the student model performance) with regard to the identified weaknesses.

While the disclosed systems are described in the context of a student/teacher model training process, it should be noted that the adversarial model training techniques disclosed herein may also be employed outside of a student/teacher model training process. For example, such adversarial model training techniques may be employed in any process for training a model by incorporating a feedback approach where training data may be selected and/or generated based on incorrect responses of a model during training. In some cases, training data representative of scenarios similar to or varied with respect to training data for which the model returned an incorrect response may be selected and/or generated for use in training the model.

Embodiments of the present disclosure are directed to techniques for improving performance of student trained model and to achieve those improvements more efficiently than by typical means (e.g., proceeding through an available dataset, adjustment the model in training, etc.) Although typical means for training may result in a situation where a student learns and improves, the improvement may be limited based on the dataset itself. For example, where an incorrect output relative to a particular image occurs, that image can be used as a starting point for a series of new training images meant to focus training of the student model where the student model has demonstrated it is weak, i.e., the particular image on which it failed previously.

Using embodiments of the present disclosure may result in a student with better performance, for example, via weights and/or biases refined multiple times using a set of “difficult cases” for which the student demonstrated weakness, as compared to if weights and/or biases were adjusted only once in response to one error among, for example, 1000 images.

In addition, embodiments of the present disclosure may allow for a predetermined level of performance (e.g., exceeding a desired accuracy threshold, etc.) to be obtained more quickly that approaches that do not employ an adversarial feedback approach. For example, using 1000 images from a base training set plus 100 test images generated based on erroneous output from the model, may result in the same level of performance increase that might be achieved through training randomly based on, for example, 1,000,000 images. Thus, not only can performance be improved more rapidly, but storage size for training data can be reduced.

Incorrect outputs may be the result of model configuration (e.g., weights and biases configuration), node relationships (e.g., in the case of a GNN), or token connection or connectivity (e.g., in the case of a transformer-based model), among other sources of incorrect inferences made by a model during training. According to one example in an autonomous vehicle scenario, a stop sign may be incorrectly interpreted by a trained model as a ‘yield’ or other sign, for example, as a result of occlusions (e.g., shadows, reflections, holes, extraneous material, etc.) affecting a feature of interest and/or the image, and this could lead to potential incorrect output. By training the student systems against such incorrect output, the students may be more robust and prepared for eventual difficult cases in actual practice.

More interesting examples tend to constitute “edge” case scenarios. For example, even a highly performing trained model may mis-identify or fail to identify a stop sign that is partly or mostly obscured by other objects in an image or that is faded, damaged, or affected by shadows. Rather than simply incorporating an arbitrary number of stop sign examples in the training data, the training of a model may be made more efficient by selecting or generating stop sign-based examples in response to a model failing to properly identify a stop sign during training. The selected or generated training data can focus on the inclusion of similar features (e.g., shadows, damage, obscuring objects, etc.) to features included in the original training data for which the model failed to return a correct response. Variations of such features may be included that represent more challenging cases than the original training data example(s).

One or more additional trained models (e.g., neural networks, Contrastive Language-Image Pre-Training (CLIP) models/networks, etc.) may be configured to monitor performance of one or more students (e.g., student neural networks) in mimicking the output of a teacher, and may identify weakness in the one or more students, such that adjustments and/or additional focused training data can be generated and/or identified, and then provided to the one or more student models. As used herein, “focused training” refers to identifying/selecting and/or generating supplemental datasets including a plurality of images or scenarios that are similar, but not identical, to the images or scenarios that caused the student returns an incorrect output. These supplemental datasets, being based on the scenario that resulted in the incorrect output, can therefore be considered to “focus” on the difficult case(s) identified as problematic for the student network. The plurality of supplemental datasets (e.g., image datasets) can then be provided to the student thereby enabling the student network to “focus” its training on images and/or scenarios that initially caused the incorrect output from the student network.

According to some embodiments, a search tool, configured to gather or otherwise identify training data examples, may receive input including scenario descriptors related to incorrect output produced by a student network. Returning to the example above, where a student incorrectly identifies a stop sign as a yield sign or other traffic indicator due to occlusions or other factors, the search tool may be provided with search criteria configured to return data sets including a plurality of stop sign examples.

Considering another example related to AVs and/or ADAS, a student network may be trained to detect whether the door of a parked car is open or opening. When approaching from behind, with good lighting, and a door fully open may be an “easy” case in which the student is readily able to detect that the door is open, because, for example, shadows are likely present and features of the inside of the door are likely visible. Thus, it should be straightforward for the student to quickly match the output of the teacher in detecting the open door. If similar images are continually provided as input to the student, further gains would likely be limited if any, even if millions of such images were provided.

On the other hand, the student may produce incorrect output in one or more scenarios represented in the initial training dataset, e.g., where the door is only slightly open, where the host vehicle is approaching at or near an angle normal to the door of the parked vehicle, and where the parked car is partially occluded by another vehicle (e.g., a truck.)

According to this example, each of the three scenarios noted above may be used to identify and/or generate multiple additional examples to provide “focused training” to the student network for each of the three cases. For example, another trained model (e.g., a generative neural network) may be provided with key words such as “car door slightly ajar,” “side view of open car door,” and “occluded open car door,” or similar, to cause the generative trained model to produce training images according to the three scenarios. The generating may be performed by one or more trained models, as desired. Alternatively, or in addition, a search engine may be implemented and provided with similar key words, the search engine being configured to identify (e.g., from other image databases), images corresponding to the three scenarios associated with the keywords.

Images identified and/or generated according to the above may then be provided to the student, and the outputs compared to those of the parent to enable adjustment of the student as described above. The process may be repeated with newly identified and/or generated image data for further incorrect output on the part of the student.

One or more search tools may be configured to locate a plurality of candidate images, for example, based on the incorrect output (e.g., stop sign examples) using text descriptors and/or image data. The one or more search tools may further be configured to identify which of the plurality of candidates most closely represents the descriptors and/or image data related to the scenario in which the incorrect output was produced, for example, based on input from a user or from the student itself.

According to some embodiments, the system may then refine the search results based on the second input to more closely correspond to the scenario resulting in the incorrect output.

The search may be enabled by using a grid approach to divide images, for example. For each grid, a signature value (feature vector) can be generated and assigned, where the smaller the grid, the fewer the number of objects are included. This may thereby render the search results more accurate.

Various software engine architectures may be used to provide the search engine functionality for identifying data sets and/or generating text descriptors pertaining to scenarios for which a student has difficulty. In some cases, the search engine may rely upon an algorithmic approach. In other cases, the search engine may include one or more trained models as part of a machine learning system. In one example, the disclosed search engine may include a CLIP (Contrastive Language-Image Pretraining) model or a CLIP model emulator to identify and return image outputs based on received input. Input to the CLIP model may be in the form of text or images. Text input to the CLIP model can cause the search engine to return images determined to agree with the text input. Vice versa, one or more images may be input to the CLIP model, and in response, the search engine may return other images similar in one or more respects to the images provided as input. For example, an adversarial training model may identify weakness in the student (e.g., incorrect stop sign classification) and may provide one or both of an image of a stop sign for which the student failed and text (e.g., “occluded stop sign”) to the search engine comprising the CLIP model to obtain a new training data set dedicated to occluded stop signs. In addition, textual outputs may also be generated based on images received as input to the CLIP model.

CLIP stands for Contrastive Language-Imaging Pretraining. CLIP is an open source, multi-modal, zero-shot model. Given a particular image and/or text descriptions, the model can predict the most relevant text description for the particular image or the most relevant image(s) to match the provided text descriptions. This functionality can be provided without optimizing for a particular task. CLIP combines natural language processing with computer vision techniques. It is considered to be a zero shot model, which refers to a type of learning involving generalizing on unseen labels, without having been specifically trained to classify the labels. Using a contrastive language technique, CLIP is trained to infer that similar representations should be close in latent space, while dissimilar representations should be farther apart. CLIP is trained using more than 400 million image-text pairs and can accurately recognize classes and objects that it has never encountered before. Among other capabilities, a CLIP model can label images in a large image dataset according to classes, categories, descriptions, etc.

Training of CLIP involves a contrastive pre-training process. For a batch of N images paired with their respective descriptions (e.g. <image1, text1>, <image2, text2>, <imageN, textN>), contrastive pre-training aims to jointly train an Image Encoder and a Text Encoder that produce image embeddings [I1, I2 . . . IN] and text embeddings [T1, T2 . . . TN], such that the cosine similarities of the correct <image-text> embedding pairs <I1,T1>, <I2,T2> (where i=j) are maximized. In a contrastive fashion, the cosine similarities of dissimilar pairs <I1,T2>, <I1,T3>. . . <Ii,Tj> (where i≠j) are minimized. Particularly, after receiving a batch of N <image-text> pairs, for every image in the batch, the Image Encoder computes an image vector. The first image corresponds to the I1 vector, the second to I2, and so on. Each vector is of size de, where de is the size of the latent dimension. Hence, the output of this step is N×de matrix. Similarly, the textual descriptions are used to generate into text embeddings [T1, T2 . . . TN], producing a N×de matrix. These matrices are multiplied to calculate the pairwise cosine similarities between every image and text description. This produces an N×N matrix. The goal is to maximize the cosine similarity along the diagonal—these are the correct <image-text> pairs. In a contrastive fashion, off-diagonal elements should have their similarities minimized.

The CLIP model uses a symmetric cross-entropy loss as its optimization objective. This type of loss minimizes both the image-to-text direction as well as the text-to-image direction. Note that the contrastive loss matrix keeps both the <I1,T2> and <I2,T1> cosine similarities.

Zero shot classification may follow pre-training of the image and text encoders. A set of text descriptions such as a “photo of a stop sign” or a “photo of a damaged yield sign” that describe one or more images are encoded into text embeddings. Next, a similar process is repeated for images and the images are encoded into image embeddings. Lastly, CLIP computes the pairwise cosine similarities between the image and the text embeddings, and the text prompt with the highest similarity is chosen as the prediction.

CLIP can understand multiple entities along with their actions in each image. Further, CLIP assigns to each image a description with a degree of specificity that agrees with the image. For instance, a particular image (e.g., one representing a traffic light with green illuminated) may be described as ‘a traffic light’ and ‘a green light’. Another image showing a close-up of a broken traffic light (e.g., no illumination) may be described as ‘a traffic light,’ but will not also be described as ‘a [color] light,’ if there is no illumination of any of the three colors (i.e., red, yellow, or green) represented in the image.

According to some embodiments, the training scenarios input for the student systems may also comprise “quality” examples representative of the hard cases. Quality examples may correspond to examples in which data is accurate, consistent, and free from errors, inconsistencies, and/or outliers. In other words, an output from a trained or training system is not likely to be erroneous based on the data itself. Quality examples are in contrast to supplying large, random datasets to the teacher/student that may contain relatively few examples where the student does not generate the same answer as the teacher and that may contain one or more errors, inconsistencies, or wrong predictions by the trained system.

According to some embodiments, when an adversary identifies weakness in output from a student network, a second network, or even the adversary itself, may be configured to generate a synthetic data set based on the scenario for which the student output was incorrect. For example, where a stop signed failed as a result of occlusions (e.g., tape, trees, paint, etc.), a trained system may create a plurality of permutations of occluded stop signs, this data set being used for further training of the student network. For example, the synthetically generated stop signs may be larger, smaller, different colors, with different occlusions, etc.

The synthetic data may then be provided as input to the teacher and the student and outputs compared to determine performance of the student in correctly identifying the previously incorrect features (e.g., occluded stop signs).

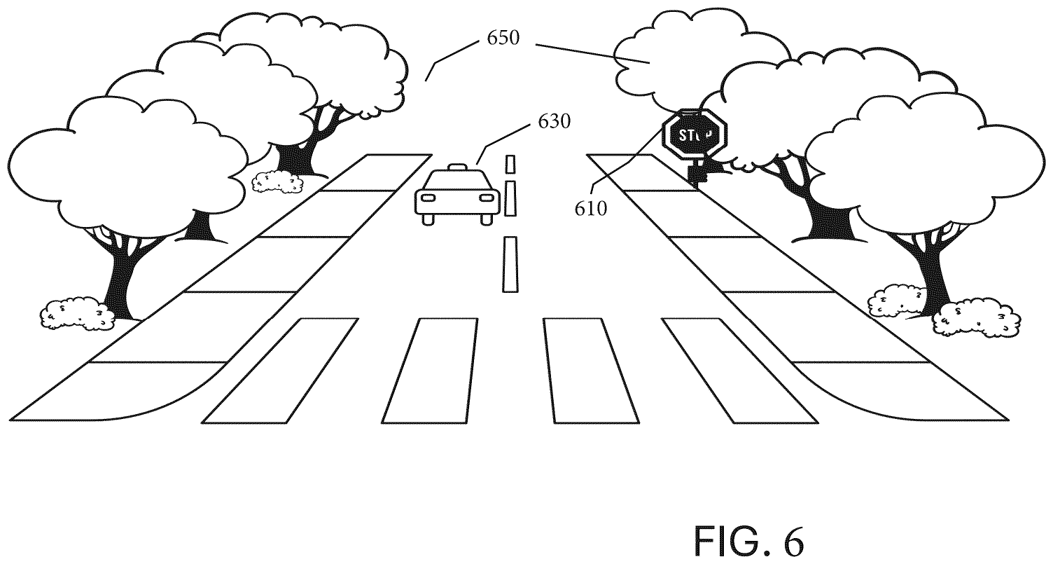

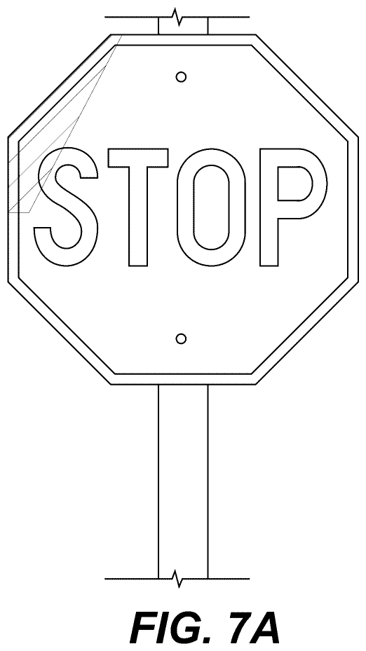

FIG. 6 provides a representation of an occluded stop sign 610 along a road segment that may cause one or more student networks to produce incorrect classification output. The stop sign 610 of FIG. 6 may be interpreted in different ways by different student models based on past training. For example, because in the image of sign 610 the letters “O” and “P” are occluded by one or more trees 650 from the viewpoint of the vehicle 630, a student network may fail to identify stop sign 610 as a stop sign, or even as a road sign at all. Other stop sign views may also present issues for identification by certain student networks, for example, a stop sign including shadow lines, additional tree branches, orientation, etc., thereby resulting in weakness of the student network.

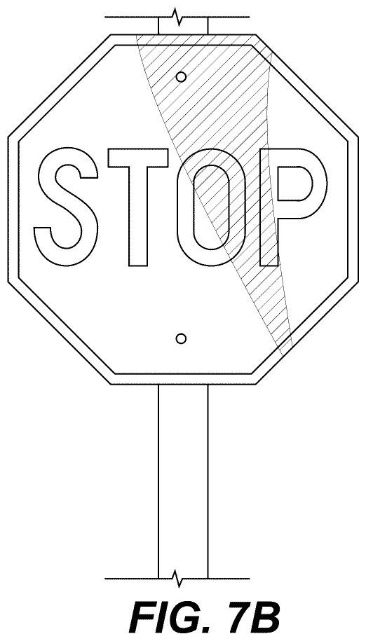

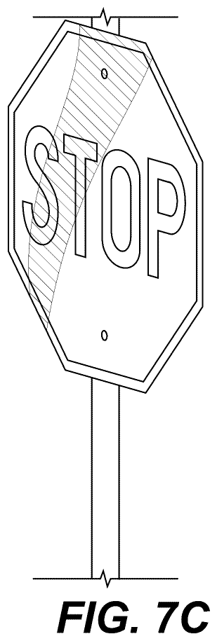

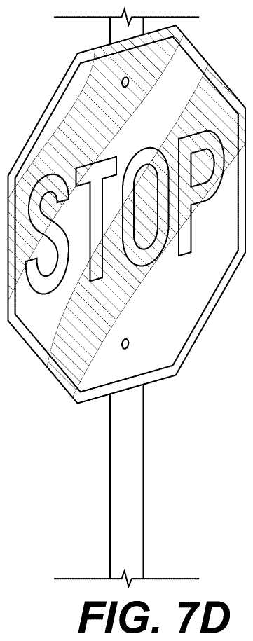

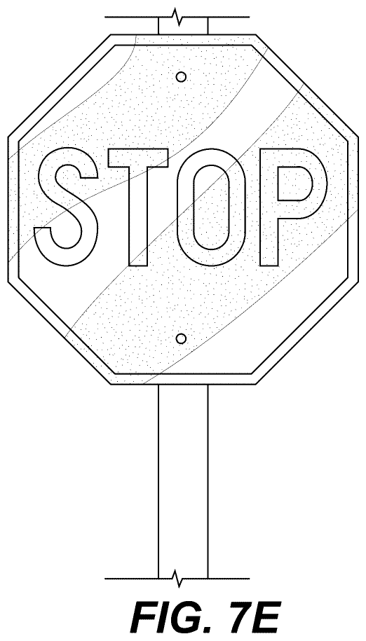

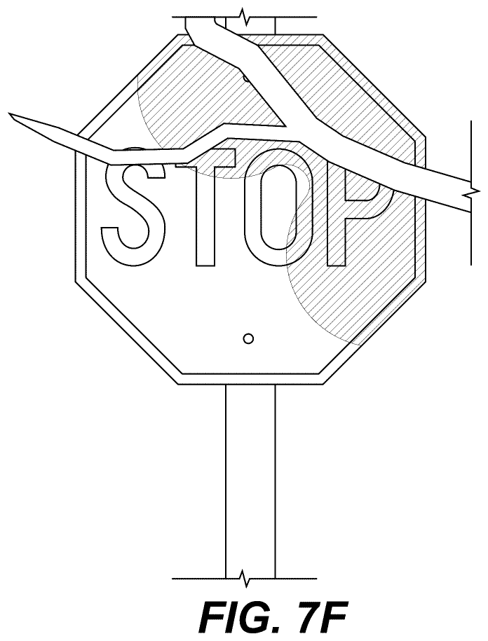

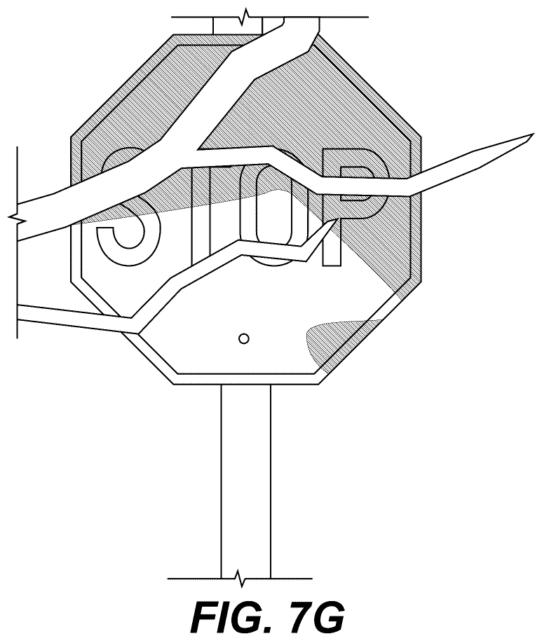

When an adversarial feedback process provided according to the present disclosure is implemented, it may identify the weakness of the student in identifying stop signs, and thus, request, e.g., from the search engine, a data set consisting of any number of variations on stop signs for providing to the student for further training. FIGS. 7A-H illustrate non-conventional stop sign views that may may be selected as training images for input to a student network for further training when weakness in stop sign identification is determined.

As shown at FIGS. 7A-7H, the supplemental training images may provide various views of stop signs including different levels of shadow, occlusions, orientations, backgrounds, etc., to facilitate training of the student model on difficult “edge” cases. Although eight images are shown as supplemental training images in the present example, the number of images can be readily increased based on real-world and synthetic examples of stop signs, e.g., from an image database.

Considering another example described above related to identifying an open state of a vehicle door, edge cases may include those noted above, where a car door is merely beginning to open, where an open door is being approached at an angle near normal to the vehicle with the open door, and where the open door is partially occluded (e.g., by another vehicle, by a cyclist, an object in the road, the leg of an exiting passenger, etc.) in an image. In such cases it may be desirable to focus training on multi-variant facets of these “edge” cases to develop and improve the skills of the student.

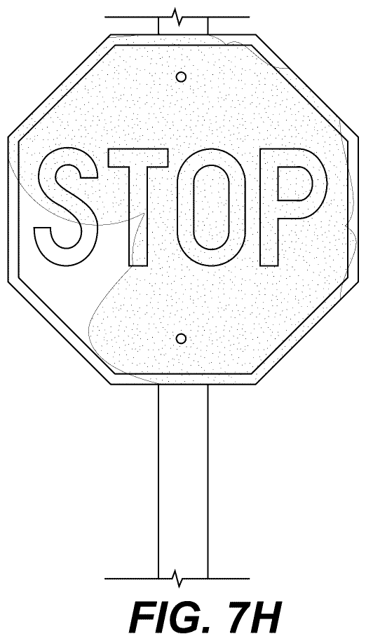

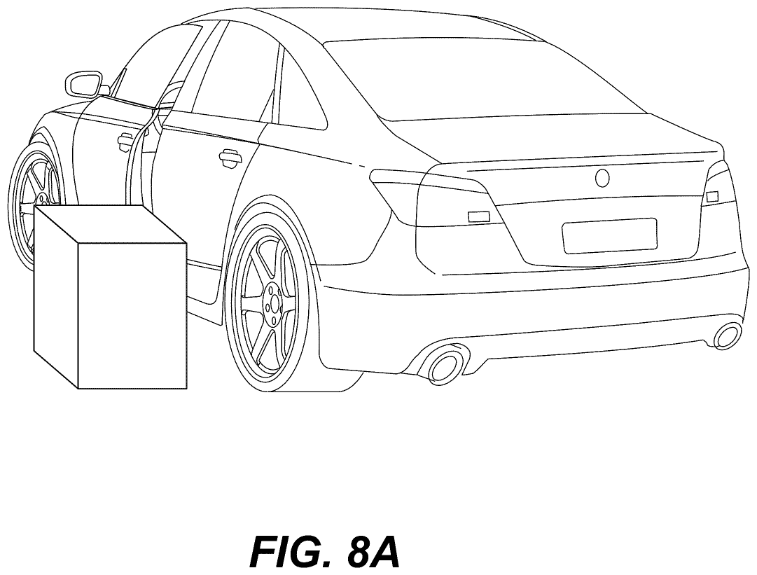

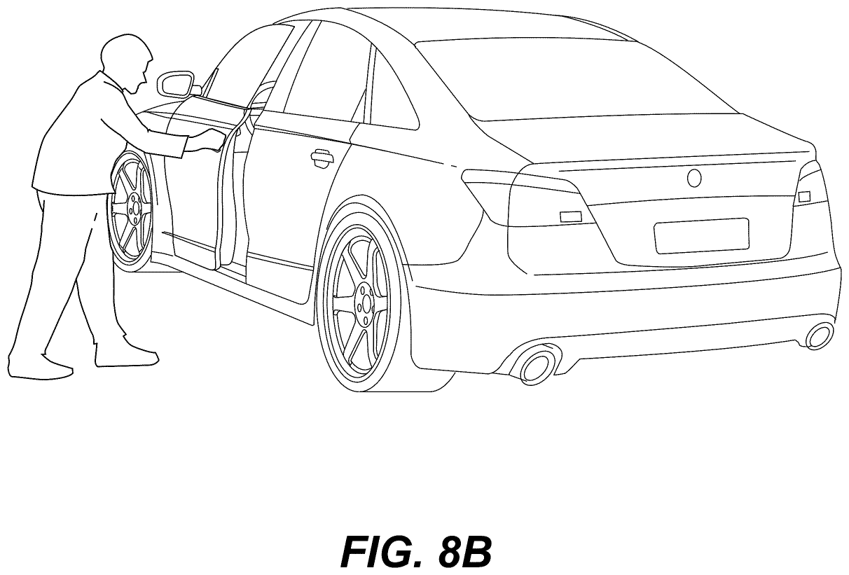

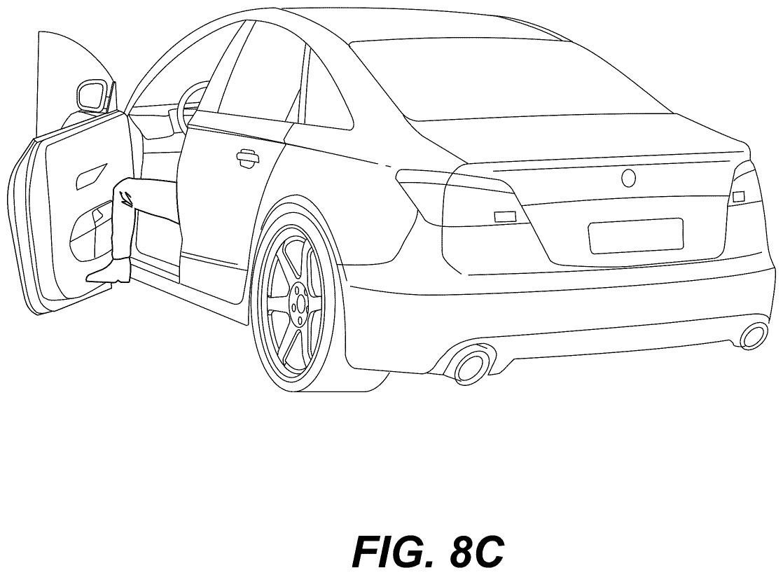

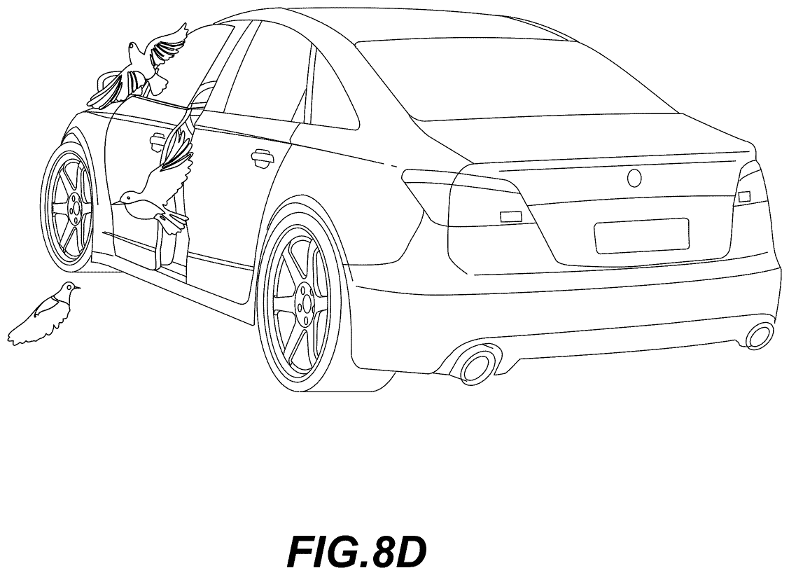

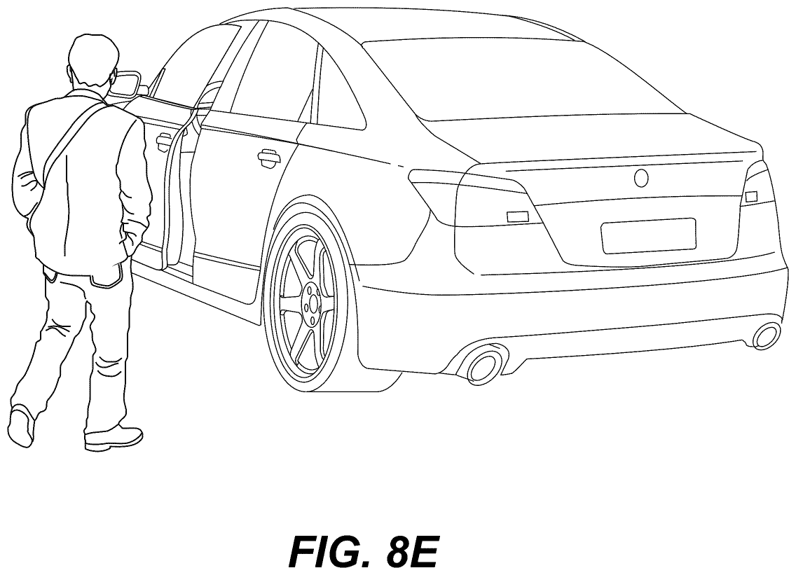

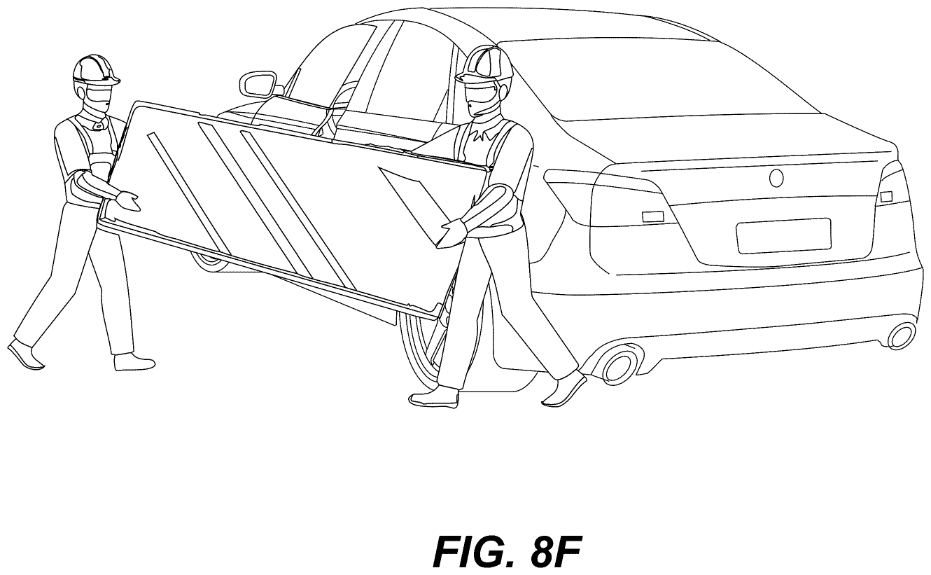

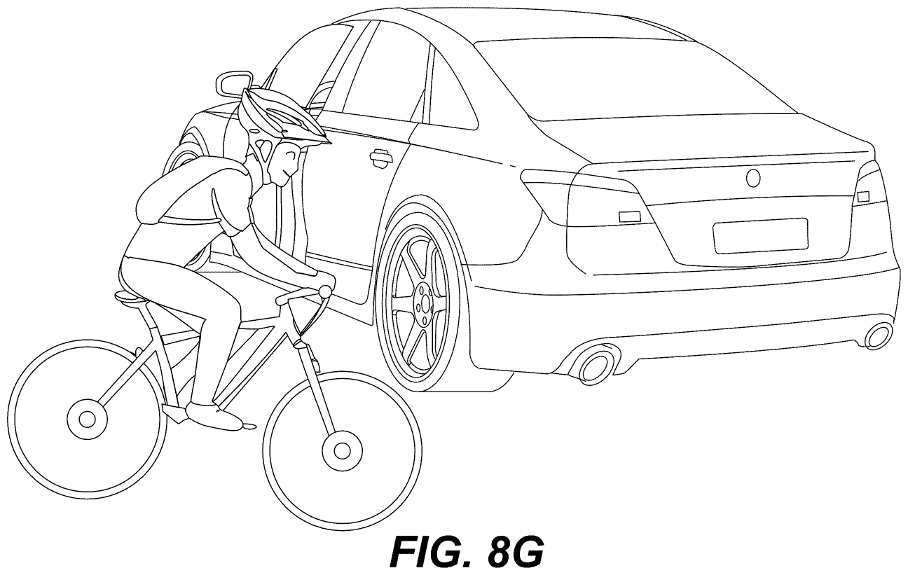

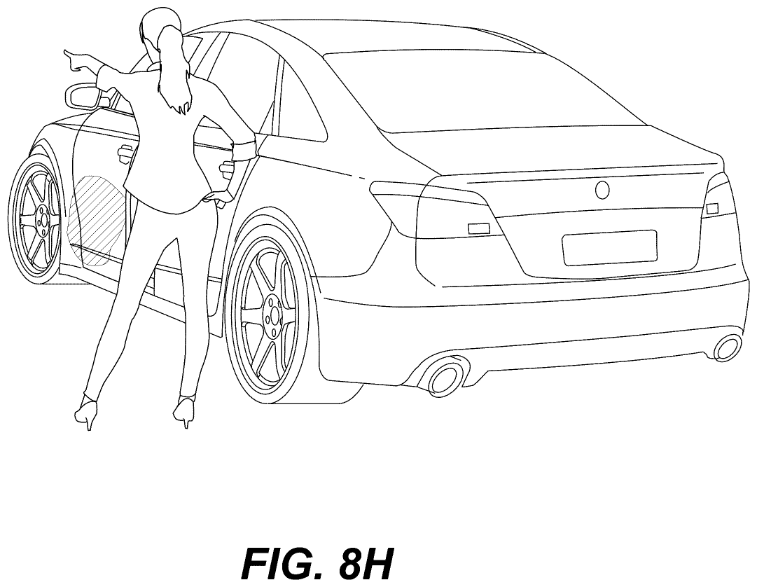

For example, FIGS. 8A-8H are examples of illustrative supplemental images related to an open car door that may be provided as input to the student network for further focused training based on identification by an adversarial network of the weakness noted above. Each of the images shown in FIGS. 8A-8H include various “difficulties” that may cause errors in classification, but that may be useful in an adversarial training configuration to aid a student network in correctly identifying other occurrences of such features going forward. As shown at FIG. 8A, an object (e.g., a box) may be present and occluding a portion of the narrowly opened door of the vehicle. As shown in FIG. 8B, a passenger is shown closing the vehicle door, and multiple frames of a closing sequence may be provided for training a student network to identify characteristics of such an action.

Various aspects of the adversarial training process may be selectively controlled (e.g., by a user) or built into the training process (e.g., by a model architect). For example, a predetermined number of new training examples may be selected or generated in response to an incorrect response/inference made by the model during training. In some cases, the predetermined number may include 10, 50, 100, or 1000 or more new training examples that may be selected or generated in response to an incorrect response by a model during training. This number may be selectable by a user or may be incorporated into the training process by a model architect. Further, the number of iterations of the adversarial feedback process and the order in which the newly selected or generated training data is presented to the model may also be selectively controlled. For example, in some cases, the process of selecting or generating new training data examples may occur immediately upon receipt of an incorrect or unexpected output generated by a model during training. New training data may be selected (e.g., from a database) or generated (e.g., synthetically generated images), and any or all of the new training data may be provided to the model prior to commencing with examples from the original training data set. Alternatively, in response to an incorrect response, one or more adjustments may be made to the model (e.g., changing of network weights, altering of node relationships or characteristics, altering of token relationships or characteristics, etc.), and prior to exposing the model to any adversarial examples, the training process may continue until all examples of the original training data set have been provided as input to the model. After exhausting all original training data examples, new training data may be selected or generated based on a subset of the original training data for which the model returned an incorrect response, and the new training data may then be supplied to the model as input.

The number of layers of adversarial feedback and training data selection/generation may also be selected or built into the training process. For example, in response to an incorrect response by a model during training, new training data may be selected or generated based on the input example that resulted in the incorrect response by the model. The new training data may be provided to the model during training, and adjustments may be made to the model in response to any incorrect responses to the new training data examples. Such an approach would involve a single layer of adversarial feedback and training data selection/generation. In some cases, however, it may be desirable to have multiple layers of adversarial feedback and training data selection/generation. For example, when providing examples to the model from the newly selected/generated training data examples, rather than only making model adjustments in response to an incorrect response by the model, one or more additional rounds of training data selection/generation can be performed in response to an incorrect response by the model. This approach may provide rapid enhancement of model performance by quickly iterating and refining the model's capabilities specific with respect to cases for which the model exhibited difficulty in characterizing. The number of levels of adversarial feedback may be capped at a desired value (e.g., 2, 5, 10, etc.) to avoid recursive training loops and to ensure that the model is exposed to a breadth of available training data.

FIG. 8C shows an exiting passenger leg occluding a portion of vehicle door, while FIG. 8D shows a number of birds scattering and occluding the vehicle door as the vehicle door begins to open. While illustrative stop signs are provided at FIGS. 7A-H and illustrative vehicle door scenarios at 8A-H, these examples are in no way intended as limiting and any features that may be desired to be classified by a student network may be used for focused training to improve performance of a student network and to address weakness in such networks. For example, traffic lights, pedestrians, cyclists, road markings, construction related objects, road vehicles, etc. may be implemented according to identified weakness in a student network.

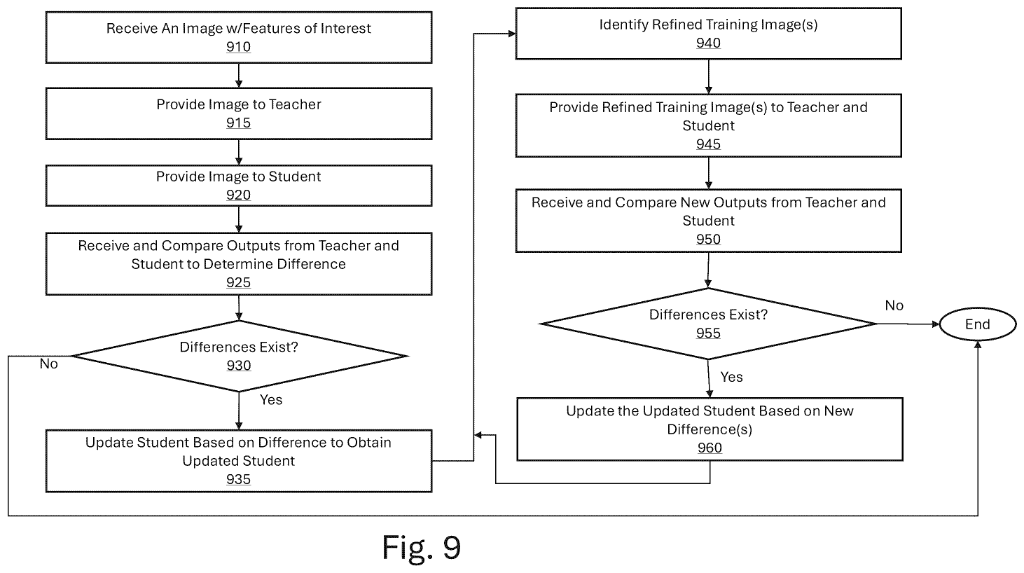

FIG. 9 is a flowchart illustrating a method for adversarial training according to embodiments of the present disclosure, including in the teacher-student model context. Returning to the techniques discussed above with regard to network training, one or more algorithms (e.g., EPL and/or RPL) acting as an adversary may identify one or more weaknesses of a student network based on differences detected in output from a teacher and the corresponding outputs from the student using the same inputs. For example, images with a feature of interest (e.g., stop signs) may be received (step 910) and provided to both the teacher (step 915) and the student (920) as inputs.

Each of the teacher and the student may then provide outputs corresponding to classifications of one or more objects present in the provided input images, including output related to features of interest and outputs compared to determine differences (step 925). The output may be generated as described above for each of the teacher network and the student network, leading to, for example output of a classified image and/or one or more classified features of interest.

According to some embodiments, the output of the teacher may correspond to a first feature vector determined by the teacher as representative of a feature of interest, for example. Similarly, the output of the student may correspond to a second feature vector determined by the student as representative of the same feature of interest. In this way, the EPL and/or the RPL may determine one or more differences between the feature vectors, for example, by calculating a Euclidian distance between the first feature vector and the second feature vector. The distance calculated may be compared to a predetermined threshold to determine whether the distance indicates that no statistically significant distance exists (step 930: no) or that a statistically significant difference exists (step 930: yes).

When no differences are determined (step 930: no) the system may determine that no further training is desired for the student with regard to a particular feature of interest. For example, when an occluded stop sign has been correctly identified as an occluded stop sign, the training related to stop signs may end.

Where one or more statistically significant differences are determined (step 930: yes), the student may be updated to adjust the response of the student to the inputs to obtain correct outputs (step 935). For example, one or more of the weights and biases of the student network may be adjusted to aid the network in correct identification of the features of interest.

Refined training images, for example, images targeting the determined difference(s) may be identified (step 940) The refined images may be representative of one or more features of interest as determined above with regard to the incorrect identifications in the output of the student network. For example, where a stop sign was incorrectly identified based on color, a refined training set may include a significant number of stop signs (e.g., greater than 80 percent of the training images) having alternate coloring. According to some embodiments, the refined training set may be obtained using the search functionality and/or the CLIP functionality and/or the synthetic generation functionality described above, or in any other desired manner.

The refined training image(s) may then be provided as input (step 945) to both the trained teacher and the student, which has been updated (i.e., the updated student) as described above based on one or more differences identified between the output of the teacher and the output of the updated student, to obtain new outputs from each of the teacher and the updated student.

Each of the outputs received from the teacher and the updated student following input of the refined training image(s) may again be indicative of the characteristic or characteristics of the feature of interest and comparison between the teacher output and student output performed (step 950) as described above at step 925. For example, where the feature of interest considered corresponds to a traffic light, one or more characteristics (e.g., shape, color, etc.) may be considered. Alternatively, or in addition, status of the one or more characteristics may be considered, for example, using the traffic light example, an illumination state of the traffic light.

Comparison of the outputs may be made to again determine whether a difference exists between the output of the updated student (updated as described above) and the teacher based on the refined image(s) as input, and where no difference is detected (step 955: no) the focused training may stop.

Where differences are identified (step 955: yes) the student network may be updated again as described with regard to step 935 and, returning to step 940, additional refined training image(s) identified.

The process may continue with automatic updates to the repeatedly updated student to until desirable output is received with regard to identification of the features of interest for which the student previously experienced difficulty.

By implementing an adversarial training approach, the accuracy and efficiency of the updated students may be improved, while also increasing the robustness of the updated students.

The following clauses relate to embodiments of the present disclosure:

### Group 1

Clause 1. A system for training a student neural network using a trained supervisory neural network, the system comprising:
at least one processor comprising circuitry and a memory, wherein the memory includes instructions that when executed by the circuitry cause the at least one processor to:
   receive an image including a representation of a feature of interest;
   provide the image as input to the trained supervisory neural network;
   provide the image as input to the student neural network;
   receive a first output from the trained supervisory neural network indicative of at least one characteristic of the feature of interest;
   receive a second output from the student neural network indicative of the at least one characteristic of the feature of interest;
   compare the first output to the second output; and
   based on a detected difference between the first output and the second output, automatically update at least one aspect of the student neural network.

Clause 2. The system of clause 1, wherein the first output is a first feature vector determined by the trained supervisory neural network as representative of the feature of interest.

Clause 3. The system of clause 2, wherein the second output is a second feature vector determined by the student neural network as representative of the feature of interest.

Clause 4. The system of clause 3, wherein the detected difference is determined by calculating a Euclidian distance between the first feature vector and the second feature vector.

Clause 5. The system of any of clauses 1-4, wherein the update of the student neural network includes changing one or more parameters of the student neural network to reduce the difference between the first output and the second output.

Clause 6. The system of clause 5, wherein changing the one or more parameters of the student neural network includes adjusting at least one weight of the student neural network.

Clause 7. The system of any of clauses 1-6, wherein the received image is not annotated.

Clause 8. The system of any of clauses 1-7, wherein the at least one aspect of the student neural network includes at least one weight associated with the student neural network.

Clause 9. The system of any of clauses 1-8, wherein the at least one aspect of the student neural network includes at least one parameter associated with the student neural network.

Clause 10. The system of any of clauses 1-9, wherein the trained supervisory neural network and the student neural network are configured to be hosted on different hardware platforms.

Clause 11. The system of any of clauses 1-10, wherein the feature of interest includes at least one of a traffic sign, a pedestrian, a vehicle, a lane marking, or a road edge.

Clause 12. The system of any of clauses 1-11, wherein the feature of interest includes a condition associated with at least one object.

Clause 13. The system of clause 12, wherein the condition includes at least one of an occlusion, a shadow, an object orientation, a traffic light illumination state, a reflectivity level, a moisture level, or an ambient light level.

Clause 14. A method for training a student neural network using a trained supervisory neural network, the method comprising:
receiving an image including a representation of a feature of interest;
providing the image as input to the trained supervisory neural network;
providing the image as input to the student neural network;
receiving a first output from the trained supervisory neural network indicative of at least one characteristic of the feature of interest;
receiving a second output from the student neural network indicative of the at least one characteristic of the feature of interest;
comparing the first output to the second output; and
based on a detected difference between the first output and the second output, automatically updating at least one aspect of the student neural network.

Clause 15. The method of clause 14, wherein the first output is a first feature vector determined by the trained supervisory neural network as representative of the feature of interest.

Clause 16. The method of clause 15, wherein the second output is a second feature vector determined by the student neural network as representative of the feature of interest.

Clause 17. The method of clause 16, wherein the detected difference is determined by calculating a Euclidian distance between the first feature vector and the second feature vector.

Clause 18. The method of any of clauses 14-17, wherein the update of the student neural network includes changing one or more parameters of the student neural network to reduce the difference between the first output and the second output.

Clause 19. The method of clause 18, wherein changing the one or more parameters of the student neural network includes adjusting at least one weight of the student neural network.

Clause 20. The method of any of clauses 14-19, wherein the received image is not annotated.

Clause 21. The method of any of clauses 14-20, wherein the at least one aspect of the student neural network includes at least one weight associated with the student neural network.

Clause 22. The method of any of clauses 14-21, wherein the at least one aspect of the student neural network includes at least one parameter associated with the student neural network.

Clause 23. The method of any of clauses 1-22, wherein the trained supervisory neural network and the student neural network are configured to be hosted on different hardware platforms.

Clause 24. The method of any of clauses 1-23, wherein the feature of interest includes at least one of a traffic sign, a pedestrian, a vehicle, a lane marking, or a road edge.

Clause 25. The method of any of clauses 14-24, wherein the feature of interest includes a condition associated with at least one object.

Clause 26. The method of clause 25, wherein the condition includes at least one of an occlusion, a shadow, an object orientation, a traffic light illumination state, a reflectivity level, a moisture level, or an ambient light level.

Clause 27. A non-transitory computer-readable medium storing instructions executable by at least one processor to perform the method according to any of clauses 1-26.

The following clauses relate to embodiments of the present disclosure:

### Group 2

Clause 1. A system for training a student neural network using a trained supervisory neural network, the system comprising:
at least one processor comprising circuitry and a memory, wherein the memory includes instructions that when executed by the circuitry cause the at least one processor to:
   receive an image including a representation of a feature of interest;
   provide the image as input to the trained supervisory neural network;
   provide the image as input to the student neural network;
   receive a first output from the trained supervisory neural network indicative of at least one characteristic of the feature of interest;
   receive a second output from the student neural network indicative of the at least one characteristic of the feature of interest;
   compare the first output to the second output; and
   based on a detected difference between the first output and the second output:
      automatically update at least one aspect of the student neural network to provide an updated student neural network;
      identify at least one refined training image also representative of the feature of interest;
      provide the refined training image as input to the trained supervisory neural network;
      provide the refined training image as input to the updated student neural network;
      receive a third output from the trained supervisory neural network indicative of at least one characteristic of the feature of interest;
      receive a fourth output from the updated student neural network indicative of the at least one characteristic of the feature of interest;
      compare the third output to the fourth output; and
      based on a detected difference between the third output and the fourth output, automatically update at least one aspect of the updated student neural network to provide a further updated student neural network.

Clause 2. The system of clause 1, wherein the refined training image is identified from an image database.

Clause 3. The system of clause 2, wherein the image database is indexed using a trained CLIP model.

Clause 4. The system of any of clauses 1-3, wherein the refined training image is identified using a trained CLIP model.

Clause 5. A method for training a student neural network using a trained supervisory neural network, the method comprising:
receiving an image including a representation of a feature of interest;
providing the image as input to the trained supervisory neural network;
providing the image as input to the student neural network;
receiving a first output from the trained supervisory neural network indicative of at least one characteristic of the feature of interest;
receiving a second output from the student neural network indicative of the at least one characteristic of the feature of interest;
comparing the first output to the second output; and
based on a detected difference between the first output and the second output:
   automatically updating at least one aspect of the student neural network to provide an updated student neural network;
   identifying at least one refined training image also representative of the feature of interest;
   providing the refined training image as input to the trained supervisory neural network;
   providing the refined training image as input to the updated student neural network;
   receiving a third output from the trained supervisory neural network indicative of at least one characteristic of the feature of interest;
   receiving a fourth output from the updated student neural network indicative of the at least one characteristic of the feature of interest;
   comparing the third output to the fourth output; and
   based on a detected difference between the third output and the fourth output, automatically updating at least one aspect of the updated student neural network to providing a further updated student neural network.

Clause 6. A non-transitory computer-readable medium storing instructions executable by at least one process to perform a method for training a student neural network using a trained supervisory neural network, the method comprising:
receiving an image including a representation of a feature of interest;
providing the image as input to the trained supervisory neural network;
providing the image as input to the student neural network;
receiving a first output from the trained supervisory neural network indicative of at least one characteristic of the feature of interest;
receiving a second output from the student neural network indicative of the at least one characteristic of the feature of interest;
comparing the first output to the second output; and
based on a detected difference between the first output and the second output:
   automatically updating at least one aspect of the student neural network to provide an updated student neural network;
   identifying at least one refined training image also representative of the feature of interest;
   providing the refined training image as input to the trained supervisory neural network;
   providing the refined training image as input to the updated student neural network;
   receiving a third output from the trained supervisory neural network indicative of at least one characteristic of the feature of interest;
   receiving a fourth output from the updated student neural network indicative of the at least one characteristic of the feature of interest;
   comparing the third output to the fourth output; and
   based on a detected difference between the third output and the fourth output, automatically updating at least one aspect of the updated student neural network to providing a further updated student neural network.

Clause 7. A system for training a student neural network using a trained supervisory neural network, the system comprising:
at least one processor comprising circuitry and a memory, wherein the memory includes instructions that when executed by the circuitry cause the at least one processor to:
   receive an image including a representation of a feature of interest;
   provide the image as input to the trained supervisory neural network;
   provide the image as input to the student neural network;
   receive a first output from the trained supervisory neural network indicative of at least one characteristic of the feature of interest;
   receive a second output from the student neural network indicative of the at least one characteristic of the feature of interest;
   compare the first output to the second output; and
   based on a detected difference between the first output and the second output:
      identify a plurality of refined training images also representative of the feature of interest;
      provide the plurality of refined training images as input to the trained supervisory neural network;
      provide the plurality of refined training images as input to the student neural network;
      receive a first plurality of outputs from the trained supervisory neural network each indicative of at least one characteristic of the feature of interest;
      receive a second plurality of outputs from the student neural network each indicative of the at least one characteristic of the feature of interest;
      compare the first plurality of outputs to the second plurality of outputs; and
      based on one or more detected differences between first plurality of outputs to the second plurality of outputs, automatically update at least one aspect of the student neural network.

Clause 8. The method of clause 8, wherein the at least one aspect of the student neural network includes at least one weight associated with the student neural network.

Clause 9. The method of any of clauses 7-8, wherein the update of the student neural network includes changing one or more parameters of the student neural network to reduce the one or more differences detected between the first plurality of outputs and the second plurality of outputs.

Clause 10. A method for training a student neural network using a trained supervisory neural network, the method comprising:
receiving an image including a representation of a feature of interest;
providing the image as input to the trained supervisory neural network;
providing the image as input to the student neural network;
receiving a first output from the trained supervisory neural network indicative of at least one characteristic of the feature of interest;
receiving a second output from the student neural network indicative of the at least one characteristic of the feature of interest;
comparing the first output to the second output; and
based on a detected difference between the first output and the second output:
   identifying a plurality of refined training images also representative of the feature of interest;
   providing the plurality of refined training images as input to the trained supervisory neural network;
   providing the plurality of refined training images as input to the student neural network;
   receiving a first plurality of outputs from the trained supervisory neural network each indicative of at least one characteristic of the feature of interest;
   receiving a second plurality of outputs from the student neural network each indicative of the at least one characteristic of the feature of interest;
   comparing the first plurality of outputs to the second plurality of outputs; and
   based on one or more detected differences between first plurality of outputs to the second plurality of outputs, automatically updating at least one aspect of the student neural network.

Clause 11. A non-transitory computer-readable medium storing instructions executable by at least one process to perform a method for training a student neural network using a trained supervisory neural network, the method comprising:
receiving an image including a representation of a feature of interest;
providing the image as input to the trained supervisory neural network;
providing the image as input to the student neural network;
receiving a first output from the trained supervisory neural network indicative of at least one characteristic of the feature of interest;
receiving a second output from the student neural network indicative of the at least one characteristic of the feature of interest;
comparing the first output to the second output; and
based on a detected difference between the first output and the second output:
   identifying a plurality of refined training images also representative of the feature of interest;
   providing the plurality of refined training images as input to the trained supervisory neural network;
   providing the plurality of refined training images as input to the student neural network;
   receiving a first plurality of outputs from the trained supervisory neural network each indicative of at least one characteristic of the feature of interest;
   receiving a second plurality of outputs from the student neural network each indicative of the at least one characteristic of the feature of interest;
   comparing the first plurality of outputs to the second plurality of outputs; and
   based on one or more detected differences between first plurality of outputs to the second plurality of outputs, automatically updating at least one aspect of the student neural network.

Clause 12: A system for training a machine learning model, the system comprising:
at least one processor comprising circuitry and a memory, wherein the memory includes instructions that when executed by the circuitry cause the at least one processor to:
   receive a training image including a representation of a feature of interest;
   provide the training image as input to the machine learning model;
   receive an output from the machine learning model including an indicator of the at least one characteristic of the feature of interest; and
   wherein the indicator of the at least one characteristic of the feature of interest differs from a predetermined indicator associated with the feature of interest:
      adjust one or more aspects of the machine learning model;
      select or generate one or more adversarial training images each including a variation of the feature of interest relative to the training image; provide the one or more adversarial training images to the machine learning model; and adjust the one or more aspects of the machine learning model in response to the machine learning model returning an output that differs from a desired output for the one or more adversarial training images.

Clause 13: The system of clause 12, wherein the machine learning model includes a neural network.

Clause 14: The system of clause 12, wherein the machine learning model includes a GNN.

Clause 15: The system of clause 12, wherein the machine learning model includes a transformer-based model.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described. Although certain features of the present disclosure are described under various headings of the text, this is not intended to delineate separate embodiments, but instead to assist the reader. In other words, the various sections of the text are intended to be utilized by those skilled in the art in various combinations for implementing embodiments of the present disclosure.

The exemplary aspects described herein are provided for illustrative purposes, and are not limiting. Other exemplary aspects are possible, and modifications may be made to the exemplary aspects. Additionally, any features disclosed in the foregoing general description and throughout the text are intended to be combinable with other features unless indicated otherwise. Therefore, the specification is not meant to limit the disclosure. Rather, the scope of the disclosure is defined only in accordance with the following claims and their equivalents.

What is claimed is:

1. A system for training a student neural network using a trained supervisory neural network, the system comprising:
at least one processor comprising circuitry and a memory, wherein the memory includes instructions that when executed by the circuitry cause the at least one processor to:
receive an image including a representation of a feature of interest;
provide the image as input to the trained supervisory neural network;
provide the image as input to the student neural network;
receive a first output from the trained supervisory neural network indicative of at least one characteristic of the feature of interest;
receive a second output from the student neural network indicative of the at least one characteristic of the feature of interest;
compare the first output to the second output; and
based on a detected difference between the first output and the second output, automatically update at least one aspect of the student neural network.

2. The system of claim 1, wherein the first output is a first feature vector determined by the trained supervisory neural network as representative of the feature of interest.

3. The system of claim 2, wherein the second output is a second feature vector determined by the student neural network as representative of the feature of interest.

4. The system of claim 3, wherein the detected difference is determined by calculating a Euclidian distance between the first feature vector and the second feature vector.

5. The system of claim 1, wherein the update of the student neural network includes changing one or more parameters of the student neural network to reduce the difference between the first output and the second output.

6. The system of claim 5, wherein changing the one or more parameters of the student neural network includes adjusting at least one weight of the student neural network.

7. The system of claim 1, wherein the received image is not annotated.

8. The system of claim 1, wherein the at least one aspect of the student neural network includes at least one weight associated with the student neural network.

9. The system of claim 1, wherein the at least one aspect of the student neural network includes at least one parameter associated with the student neural network.

10. The system of claim 1, wherein the trained supervisory neural network and the student neural network are configured to be hosted on different hardware platforms.

11. The system of claim 1, wherein the feature of interest includes at least one of a traffic sign, a pedestrian, a vehicle, a lane marking, or a road edge.

12. The system of claim 1, wherein the feature of interest includes a condition associated with at least one object.

13. The system of claim 12, wherein the condition includes at least one of an occlusion, a shadow, an object orientation, a traffic light illumination state, a reflectivity level, a moisture level, or an ambient light level.

14. A method for training a student neural network using a trained supervisory neural network, the method comprising:
receiving an image including a representation of a feature of interest;
providing the image as input to the trained supervisory neural network;
providing the image as input to the student neural network;
receiving a first output from the trained supervisory neural network indicative of at least one characteristic of the feature of interest;
receiving a second output from the student neural network indicative of the at least one characteristic of the feature of interest;
comparing the first output to the second output; and
based on a detected difference between the first output and the second output, automatically updating at least one aspect of the student neural network.

15. The method of claim 14, wherein the first output is a first feature vector determined by the trained supervisory neural network as representative of the feature of interest.

16. The method of claim 15, wherein the second output is a second feature vector determined by the student neural network as representative of the feature of interest.

17. The method of claim 16, wherein the detected difference is determined by calculating a Euclidian distance between the first feature vector and the second feature vector.

18. A non-transitory computer-readable medium storing instructions executable by at least one processor to perform a method for training a student neural network using a trained supervisory neural network, the method comprising:
receiving an image including a representation of a feature of interest;
providing the image as input to the trained supervisory neural network;
providing the image as input to the student neural network;
receiving a first output from the trained supervisory neural network indicative of at least one characteristic of the feature of interest;
receiving a second output from the student neural network indicative of the at least one characteristic of the feature of interest;
comparing the first output to the second output; and
based on a detected difference between the first output and the second output, automatically updating at least one aspect of the student neural network.

19. The non-transitory computer-readable medium of claim 18, wherein the first output is a first feature vector determined by the trained supervisory neural network as representative of the feature of interest.

20. The non-transitory computer-readable medium of claim 19, wherein the second output is a second feature vector determined by the student neural network as representative of the feature of interest.

21. The non-transitory computer-readable medium of claim 20, wherein the detected difference is determined by calculating a Euclidian distance between the first feature vector and the second feature vector.
